(19) United States
(12) Patent Application Publication
(10) Pub. No.: US 2023/0337685 A1
(43) Pub. Date: Oct. 26, 2023

(54) COMPOSITION AND METHOD OF TREATING BACTERIAL AND VIRAL PATHOGENS IN PLANTS

(71) Applicant: Greening Be Gone, LLC, Fredericksburg, VA (US)

(72) Inventors: Winsor Gebhard Eveland, Englewood, FL (US); Vasilios Peter Fotopoulos, Ijamsville, MD (US)

(21) Appl. No.: 17/627,112

(22) PCT Filed: Jul. 16, 2020
(86) PCT No.: PCT/US2020/042288

§ 371 Date: Jan. 13, 2022

Related U.S. Application Data
(60) Provisional application No. 62/874,555, filed on Jul. 16, 2019.

(51) Int. Cl. A01N 65/06; A01N 59/08; A01N 65/03

(52) U.S. Cl. CPC A01N 65/06; A01N 59/08; A01N 65/03

(57) ABSTRACT

Antimicrobial compositions comprising gum rosin, pine oil, and salt water mitigate or eliminate detrimental plant microorganisms, and mitigate or reverse plant diseases such as Gram-negative bacterial diseases. The compositions are effective against Gram-negative bacterial diseases (including citrus greening disease or HLB caused by Candidatus Liberibacter, and diseases caused by Xylella fastidiosa), fungal diseases such as those caused by Candida auris, and viral diseases such as those caused by Citrus tristeza virus. The antimicrobial compositions may be used as a root treatment, foliar treatment, or both. The compositions can be diluted into a concentrated mixture and sprayed on the leaves of a diseased plant, or a plant that is prone to disease. The compositions can be used as a root drench or in an irrigation system to treat a diseased plant. The compositions may optionally include surfactants (especially in foliar applications) and growth stimulants (especially in root drench or irrigation applications).

The present application claims the benefit of PCT/US2020/042288, filed Jul. 16, 2020, which claims the benefit of s, filed Jul. 16, 2019, which is hereby incorporated by reference herein in its entirety.

### FIELD OF THE INVENTION

The field of the invention is the treatment of plants that are subject to bacterial diseases including diseases caused by Gram-negative bacteria (including citrus greening disease or HLB caused by Candidatus Liberibacter, and diseases caused by Xylella fastidiosa or by Pseudomonas spp.), fungal diseases such as those caused by Candida auris or Phytophthora spp., and viral diseases caused by pathogens such as Citrus tristeza virus. The compositions including pine oil, gum rosin, and salt water described herein are useful for treating, e.g., plant foliage, plant roots, or both foliage and roots.

### BACKGROUND OF THE INVENTION

Citrus Huanglongbing (HLB), better known as citrus greening disease, was first detected in 2005 in the United States in citrus trees in the suburbs of Miami, Florida. The disease is caused by Candidatus Liberibacter, also known as Citrus Greening, which is a Gram-negative bacteria, spread by the psyllids Trioza erytrea and Diaphorina citri, acting as natural vectors. The pathogens penetrate a plant's phloem and attack the vascular system, clogging the veins and drastically reducing the transport of water and nutrients. There are several varieties of Candidatus Liberibacter bacteria that has been detected in Asia, Africa, the United States, Mexico, and South and Central America.

Xylella fastidiosa is another Gram-negative bacterium disease that is also transmitted to plants by vectors. It was first detected in commercial grape vines in California in 1996. The glassy-winged leafhopper vectors are the cause for Pierce's disease in grapes, phony peach, quick decline syndrome in olives, almonds, cherry, oleanders, as well as other plants, and Citrus Variegated Chlorosis in citrus. These diseases have currently reached epidemic levels in California, Italy, Spain and France.

At present, there is no known cure for either Candidatus Liberibacter or Xylella fastidiosa bacterium diseases. Several experimental treatments have not proved effective against combating these diseases. Oxy-tetracycline, streptomycin sulfate and copper have been the main chemicals available to treat bacterial plant diseases in the US. They have not proved successful in mitigating these Gram-negative bacterial diseases. Thermal Therapy Heat Treatment equipment has been tried and found to be ineffective. A nine million dollar USDA-funded “Rear Release Psyllids as Bio Control Agents Project” was also tried between 2012 and 2017. No positive results were documented during this five-year trial as well. See https://portal.nifa.usda.gov/web/crisprojectpages/0230893-rear-and-release-psyllids-as-biological-control-agents-an-economical-and-feasible-mid-term-solution-for-huanglongbing-hlb-disease.html.

WO 2019/147466 describes a composition and method utilizing the composition that includes citrus oil, pine oil and salt water. It has been discovered, however, that there can be variability in the quality of the citrus peel that is available for use. This variability may create an ambiguity in the effectiveness of the product. Furthermore, citrus pathogens such as C. Liberibacter and Xylella fastidiosa have also degraded the quality of the essential oils in citrus peel, making quality citrus peel potentially scarce. In addition, citrus peel requires excessive processing in order to obtain a small enough particle size that will not clog irrigation equipment like micro-jets.

The phenomenon of destructive plant crop disease puts fruit production and supply, and the fruit farming industry, at serious risk. By 2017, estimates of economic damage were in the billions of U.S. dollars. See https://www.usda.gov/media/press-releases/2017/01/19/usda-invests-136-million-citrus-greening-research. Destructive and persistent infections and disease of plant crops by Gram negative bacteria and other microbial pathogens have been reported after treatment with currently available antimicrobial agents. Thus, there is a need in the art to be able to prevent and mitigate diseases caused by such pathogens in fruit crops. There is a further need to solve this problem using compositions without synthetic chemicals, antibiotics, or other drugs, which are known to cause harmful effects in the environment and humans.

### BRIEF DESCRIPTION OF THE DRAWINGS

FIG. 1 depicts the results of juice weight analysis (pounds per fruit) of Hamlin oranges picked from treated and untreated trees infected with Citrus Greening, as well as the Florida average juice weight for Hamlin oranges.

FIG. 2 depicts the net value of juice solids per acre (after treatment cost) of Hamlin oranges picked from treated and untreated trees infected with Citrus Greening, as well as the Florida average for Hamlin oranges.

FIG. 3 depicts the results of a fruit yield analysis (boxes per acre) of Hamlin oranges picked from treated and untreated trees infected with Citrus Greening, as well as the Florida average yield for Hamlin oranges.

FIG. 4 depicts the results of a Brix/acid ratio analysis of Hamlin oranges picked from treated and untreated trees infected with Citrus Greening, as well as the Florida average Brix/acid ratio for Hamlin oranges.

FIG. 5 depicts the results of a fruit yield analysis (by pounds) of Hamlin oranges picked from treated and untreated trees infected with Citrus Greening, as well as the Florida average yield by pounds for Hamlin oranges.

FIG. 6 depicts the results of leaf bacterial analysis of treated and untreated (control) olive trees infected with Xylella fastidiosa at two different sampling dates. The results are provided in measurements of Xylella fastidiosa colony forming units per milliliter (CFU/mL) are provided for treatments using the specified compositions.

FIG. 7 depicts measurements of changes, between Mar. 6, 2020 and May 25, 2020 sampling dates, of Xylella fastidiosa CFU/mL for the specified compositions resulting from a leaf bacterial analysis on both treated and untreated (control) olive trees infected with Xylella fastidiosa.

FIGS. 8 and 9 depict percent changes, between Mar. 6, 2020 and May 25, 2020 sampling dates, of Xylella fastidiosa CFU/mL for the specified compositions resulting from a leaf bacterial analysis on both treated and untreated (control) olive trees infected with Xylella fastidiosa.

FIG. 10(a) depicts a photograph showing olive trees infected with Xylella fastidiosa, which are undergoing treatment application.

FIG. 10(b) depicts a photograph showing olive trees infected with Xylella fastidiosa treated with Composition Gamma.

FIG. 10(c) depicts a photograph showing new flush on an olive tree after treatment with Composition Gamma.

FIG. 11 depicts total new flush lengths of 30 tagged branches/treated/untreated category on May 25 vs Mar. 6 2020 (date of first application).

FIG. 12 depicts average branch growth and branch loss due to Xylella of 30 tagged branches/treated vs. untreated trees on May 25th compared to Mar. 6 2020 (date of 1st application).

FIG. 13 depicts average decrease in Xylella bacteria colony forming units/mL in treated vs untreated trees on May 25th compared to Mar. 6 2020 (date of 1st application).

FIGS. 14(a) and 14(b) depict photographs of untreated and treated (respectively) CTV-infected Tarocco blood orange trees.

FIGS. 15(a) and 15(b) depict photographs of untreated and treated (respectively) CTV-infected Tarocco blood orange trees.

FIG. 16 depicts a photograph of a treated CTV-infected Tarocco blood orange tree.

### SUMMARY OF THE INVENTION

The present invention addresses the need in the art for the treatment of plant crops infected with microbial pathogens or prone to microbial disease. In such situations, potent and effective antimicrobial activity and disease symptom treatment are particularly necessary. Accordingly, it is an object of the present invention to provide a composition and method for treating plants that are exposed or otherwise prone to detrimental microorganisms including, but not limited to, Gram-negative bacterial diseases. Using the antimicrobial compositions described herein, the disease is mitigated or reversed.

The antimicrobial compositions described herein are unexpectedly able to significantly reduce pathogen burden in the plant and restore the flow of nutrients through the phloem or xylem. Surprisingly, the combination of gum rosin derivatives with pine oil in the composition results in significantly increased mitigation and elimination of plant microbial diseases. The antimicrobial compositions described herein contain antimicrobial and nutritive active ingredients that exhibit a combination of attributes—including biocidal activity against disease-causing microbial pathogens such Citrus Greening and Xylella fastidiosa, reversing or eliminating disease symptoms, restoring nutrient flow in vascular tissue, facilitating systemic acquired resistance in the plant, and repelling vectors which spread the microbial pathogens—that position these compositions to be an optimal solution for the need in the art for a treatment of diseased crops and increased fruit production.

In some embodiments, an antimicrobial composition comprises a treatment of plants prone to microbial disease, wherein the composition includes pine oil, gum rosin, and salt water. The relative amounts, as measured by volume, of the three components as compared with each other are:
a) 0.5-75% pine oil;
b) 0.01-70% gum rosin derivatives; and
c) 15-95% salt water.

In some embodiments, the antimicrobial composition may be used as a foliar application, as a root application, or both. In certain embodiments the antimicrobial composition may further include any surfactant and the relative amount, as measured by volume, of the surfactant is 0.05-30%. The antimicrobial composition may further include a growth stimulant, and the relative amount, as measured by volume, of the growth stimulant is 0.1-20%. The growth stimulant may include humic acid and/or fulvic acid or mixtures thereof.

In certain embodiments, an antimicrobial composition comprises a treatment of plants prone to Gram-negative bacterial disease, wherein the composition includes gum rosin, pine oil, salt water, a surfactant, and a growth stimulant. The relative amounts, as measured by volume, of the five components as compared with each other are:
a) 0.01-70% gum rosin;
b) 0.5-75% pine oil;
c) 15-95% salt water;
d) 0.05-30% surfactant; and
e) 0.1-20% growth stimulant.

In certain embodiments, a method of treating a plant prone to Gram-negative bacterial disease comprises providing a composition including gum rosin, pine oil, and salt water, wherein the relative amounts, as measured by volume, of the three components as compared with each other are:
a) 0.01-70% gum rosin;
b) 0.5-75% pine oil;
c) 15-95% salt water; and
   applying the composition to the plant in an amount effective to mitigate the Gram-negative bacterial disease.

In certain embodiments, a method of treating the foliage of a plant prone to Gram-negative bacterial disease comprises providing a composition including gum rosin, pine oil, salt water, and a surfactant wherein the relative amounts, as measured by volume, of the four components as compared with each other are:
a) 0.01-70% gum rosin;
b) 0.5-75% pine oil;
c) 15-95% salt water;
d) 0.05-30% surfactant; and
   applying the composition to the foliage of the plant in an amount effective to mitigate the Gram-negative bacterial disease.

In certain embodiments, a method of treating the roots of a plant prone to Gram-negative bacterial disease comprises providing a composition including gum rosin, pine oil, salt water, and a growth stimulant wherein the relative amounts, as measured by volume, of the four components as compared with each other is
a) 0.01-70% gum rosin;
b) 0.5-75% pine oil;
c) 15-95% salt water;
d) 0.01-20% growth stimulant; and
   supplying the composition to the roots of the plant in an amount effective to mitigate the Gram-negative bacterial disease.

In certain embodiments, the antimicrobial composition comprises seaweed. In certain embodiments, the antimicrobial composition comprises pine oil, gum rosin, and seaweed. In other embodiments, the antimicrobial composition comprises pine oil and seaweed without gum rosin.

### DETAILED DESCRIPTION OF THE INVENTION

It has been discovered in the present invention that a composition that comprises gum rosin, pine oil, and salt water is effective in mitigating and reversing the symptoms of plant pathogens. It has been determined that bacterial and fungal colony-forming organisms are present in the phloem and xylem pathways of the infected plants. These pathogen colony-forming organisms restrict water and nutrients from circulating through these vascular pathways until the pathways are completely clogged, and the plant dies from water and nutrient suffication. The antimicrobial composition and methods herein decrease the levels of pathogen colony-forming organisms infecting the plant, thus improving the vascular pathway activity necessary for the increase the circulation of water and nutrients in the plant. This mixture is an effective, safe, and natural treatment to reverse the negative pathogen symptoms caused by Citrus Greening (HLB), Xylella fastidiosa, Citrus tristeza virus and other Gram-negative bacteria and viral pathogens. A mixture containing gum rosin, pine oil, and salt water can be used as a foliar treatment by diluting a concentrated mixture of the composition and spraying it on the leaves of a diseased plant or one that is prone to disease. Similarly, the antimicrobial composition can be used as a root drench or in any irrigation system to treat diseased plants. Additionally, active components in a composition as disclosed herein may optionally include a surfactant (especially in a foliar application) and a growth stimulant (especially in a root drench or irrigation application).

In certain embodiments, the antimicrobial compositions and methods herein involve the use of the composition to prevent, mitigate, or reverse Gram-negative bacterial disease, including but not limited to diseases caused by Candidatus Liberibacter, Xylella fastidiosa, Pseudomonas spp., and Xanthomonas spp. In other embodiments, the antimicrobial composition is used to prevent, mitigate, or reverse diseases caused by microorganisms including but not limited to fungal diseases such as those caused by C. auris, viral diseases such as those caused by Citrus tristeza virus, and other diseases, such as root rot, caused by Phytophthora spp. In certain embodiments, the antimicrobial composition is used to prevent, mitigate, or reverse infections caused or exacerbated by two or more microorganisms, such as Xylella fastidiosa and C. auris. In other embodiments, the antimicrobial composition is used to prevent, mitigate, or reverse diseases caused by Xanthomonas campestris, X. fragariae, X. amepelina, X albilineans, or X. axonopodis.

In one example, there may be a two-step approach to cure Gram-negative bacteria diseases like the HLB Citrus Greening disease as well as other similar plant diseases. First, the treatment is directed to an entire citrus tree, from the root system to the tree's canopy. Tests have shown that if a user treats both the canopy and the root system with a foliar spray and a thorough root drenching, the tree will be able to reverse the disease. Continued use of the product will further strengthen the tree's immune system, rendering it less likely that it will contract the pathogen again. The incentives to the grower to encourage its continued application include larger fruit, better quality fruit, less fruit drop, higher pound solids. The present composition is a natural solution which will not cause any harmful residue in the fruit, add toxins to the soil and underground water, will not cause bacterial resistance, and any potential “runoff” of this mixture into the waterways will not feed harmful toxic causing bacteria like “Red Tide” affecting at least several regions in the U.S. (especially Florida and Texas).

Applications of this invention include but are not limited to the ability to treat citrus trees (such as Valencia orange, Blood orange, grapefruit, and murcott (hybrid mandarin-orange variety) trees), olive trees, almond trees, and grapevines. Plants which may benefit from the present invention include but are not limited to fruit crops which are prone to microbial infections, those which exhibit a microbial disease, and those which are infected by a microbial pathogen.

Diseases prevented, mitigated, or reversed by this invention include but are not limited to Citrus greening disease, citrus canker, root rot, bacteria leaf spot, and leaf scaled disease. Disease symptoms prevented, mitigated, or reversed by this invention include but are not limited to chlorosis, phloem plugging, twig or limb dieback, fruits that are green, misshapen or bitter, and fruit drop.

Olive tree quick decline begins with rapid dieback of branches and twigs, also known as “flagging.” Symptoms of an olive tree with Xylella typically begin in the upper branches and spread throughout the crown within a month or two. As a result, the tree takes on a scorched appearance. In certain embodiments, the antimicrobial composition reverses the flagging of olive trees.

In certain embodiments, the antimicrobial composition provides the infected tree with a natural systemic treatment to defeat the disease. The treatment increases the nutritional and anti-microbial components needed by the tree during the drenching of the roots in a three-foot radius area around the tree trunk. In certain embodiments, natural humic and fulvic acids are in the formula and provide plant and root stimulant elements. These stimulants strengthen the roots and promote root growth. The stronger root system in turn increases the absorption of the nutritional minerals found in the humic/fulvic acids, salt water, as well as gum rosin blend ingredients. Furthermore, the stronger root system also fosters the absorption of the antimicrobial elements in the pine oil and gum rosin blend ingredients. Without being limited by theory, with regard to effectiveness against bacterial pathogens, it is believed that this anti-microbial component of the treatment gradually decreases the phloem-restricting bacteria clogging the tree's phloem tubes, which “unclogs” the tubes. Eventually, these anti-microbial elements clear the clogged phloem tubes of the tree. Clear phloem tubes allow water and treatment nutrients to flow throughout the tree including its trunk, branches, leaves, and fruit. With this extra emphasis on the revitalized root system, the treatment will dramatically improve the tree's own immune system. Thus, in some embodiments, the treatment provides the tree an opportunity to recover from, mitigate, or destroy this disease internally from the bottom/up. Furthermore, treatments provide the tree with the opportunity to defend itself against future attacks by these pathogens.

In certain embodiments, the foliar spray application of the anti-microbial composition to the foliar canopy of the tree may be important in assisting the tree to kill the disease. In certain embodiments, the pine oil (enhanced with the gum rosin blend) also acts like an insecticide to kill vector psyllids (and psyllid eggs). In further embodiments, a surfactant is in the composition and serves as a “sticker,” so the treatment adheres to the leaves and branches of the tree. This adhesion allows more time for the treatment to be absorbed by the leaves. The anti-microbial properties of the pine oil (enhanced by the gum rosin blend) also serves as a psyllid (vector) repellant. By repelling these vectors, the tree is spared further infestation. The anti-microbial and nutritional treatment then travels from the leaves to the phloem of the tree. This enables the treatment to attack the bacteria in the tree's phloem system and at the same time provide much needed nutrition to the tree from the top down.

The double-barreled (top/down and bottom/up) approach used in certain embodiments to treating difficult plant diseases (like HLB Citrus Greening) is believed to be unique. This method uses an appropriate mixture of “nature's medicines” to provide many of the important minerals, ions, nutritional elements, and anti-microbial supplements, will enable the tree to achieve a Systemic Acquired Resistant agent (SAR). This is an effective approach to treat HLB/Citrus Greening and many other diseases caused by microorganisms that are detrimental to the agricultural industry, including but not limited to diseases caused by Gram-negative bacteria such as Xylella fastidiosa, Pseudomonas spp., and Xanthomonas spp., diseases caused by fungi such as C. auris, diseases caused by viruses such as Citrus tristeza virus, and other diseases, such as root rot, caused by Phytophthora spp.

Each of the active composition components and methods of their use are discussed in more detail separately in the following.

Natural pine oil is derived from turpentine which is distilled from gum rosin, tall oil, or wood rosin. Gum rosin is harvested by tapping the live pine tree. Tall oil is a by-product of the paper/pulp process. Wood rosin is chemically extracted from the stumps of pine trees. Pine oils can also be extracted from boiling pine needles. There are also additional methods to extract pine oils from the sources mentioned above. Synthetic pine oil is derived from the hydration of turpentine in a reactor followed by fractionation to separate the different cuts of alcohols, terpene hydrocarbons, and other fractions. It should be noted that all references to pine oil in this formulation refer to either natural or synthetic pine oil. The EPA registered pine oil products can also be used in the present composition. Currently there are 12 active pine oil registrations (1 Registered Pine Oil Manufacturer) registered under Section 3 of the Federal Insecticide, Fungicide, and Rodenticide Act (FIFRA). Pine oils are generally effective for and are used as a disinfectant, sanitizer, microbiocide/microbiostat, virucide, and insecticide. Some of the target pests when pine oil is used include brevibacerium ammoniagenes, Candida albicans, enterobacteraerogenes, Escherichia coli, Gram-negative enteric bacteria, household germs, Gram-negative household germs such as those causing salmonellosis, herpes simplex types 1 and 2, influenza type A, influenza virus type A/Brazil, influenza virus type A2/Japan, intestinal bacteria, Klebsiella pneumoniae, odor-causing bacteria, mold, mildew, Pseudomonas aeruginosa, Salmonella choleraesuis, Salmonella typhi, salmonella typhosa, Serratia marcescens, shigella sonnei, Staphylococcus aureus, streptococcus faecalis, Streptococcus pyogenes, trichophyton mentagophytes. It should be noted that both Candidatus Liberibacter and Xylella fastiodosa that cause citrus greening are Gram-negative bacteria.

Pine oil is a relatively reliable ingredient. Reliable supply, consistent quality, and price stability are additional benefits of pine oil. One acceptable pine oil for use in the present composition is El Pinol 85 Pine Oil (including El Pinol 85), which is an approved EPA registered active ingredient for indoor anti-microbial disinfectant applications. El Pinol 85 EPA Registration # is 11668-3 and it has been registered since May 14, 1974. In June 2017 El Pinol 85 was approved by The National Association for Sustainable Agriculture, Australia (NASAA) as the active ingredient for outdoor organic agricultural herbicide applications. El Pinol 85's purpose as the active ingredient in the present composition in the example of citrus greening is to assist in eradicating the C. Liberibacter and Xylella fastidiosa bacteria, eradicating the infectious vectors from the leaves of the diseased citrus trees, and repelling these vectors from re-infecting the citrus trees or other prone plants. It is a natural substance fractured from Gum Turpentine, which is derived from pine resin. Its added safety advantage is that documented toxicological studies over the past 40 plus years prove that pine oil is not harmful to humans or animals.

The chemical composition of El Pinol 85 includes the following compounds that are believed to contribute to the effectiveness of this composition:
1) Alpha-Terpineol
2) Terpinolene
3) Limonene
4) α-pinene
5) Myrcene
6) Fenchyl Alcohols (α & β)
7) Terpene Alcohols

El Pinol 85 (85% Terpene Alcohols) is one pine oil ingredient used in certain embodiments in the antimicrobial composition.

Other liquid terpenes that can serve as substitutes for this pine oil ingredient and are included in the definition of pine oil herein include:
1) Pine oil with a range of Terpene Alcohols from 5% to 100%
2) Dipentene
3) Gum Turpentine
4) Natural pine oil
5) α-Pinene (derived Gum Turpentine, Crude Tall Oil, and Crude Sulfate Turpentine)
6) Tall Oil and Tall Oil Fatty Acids
7) Castor Oil
8) Oleoresins

Gum rosin or wood rosin is one of the ingredients included in embodiments of the antimicrobial composition. Rosin is the solid substance derived from resin from coniferous trees, after the volatile turpentine is extracted. The major constituents of rosin are identified as sandaracopimaric acid, isopimaric acid, palustric acid, dehydroabietic acid, abietic acid, neoabietic acid, and merkusic acid. It serves as a natural emulsifier in the composition. Additionally, it also serves as a natural surfactant to help the composition bind better to the root and foliar of the treated plant. The terms “gum rosin” shall be defined and interpreted broadly with respect to the present invention. The term “gum rosin” is used to also reference wood rosin and also the coniferous tree resins from which the rosin is derived. Additional compositions that are considered to be included in the definition of “gum rosin”, in addition to gum rosins and wood rosins generally, include the following:
1) Oleoresins
2) Resin
3) Ester Gum
4) Hydrogenated Gum Rosin/Wood Rosin
5) Glycerol Ester of Gum Rosin
6) Glycerol Ester of Wood Rosin
7) Fumaric Resin

It has been discovered that gum rosin decreases the volatility of the overall composition described herein so that when the product is applied to the soil, it allows for better penetration to a plant's root system.

It has also been determined that gum rosin, when added to the composition and applied to the soil, removes glyphosate residue from a plant's roots. Glyphosate residue is widely found in soils and water tables generally where a glyphosate material has been applied for weed control. The removal of glyphosate residue from the roots by the addition of gum rosin to the composition allows a plant's roots to better absorb nutrients from the soil. The improved efficiency of the root system results in a healthier plant. A healthier plant has a healthier immune system, which is advantageous to successfully resist plant pathogens like C. Liberibacter and Xylella fastidiosa.

In further embodiments, any one of the pine oil ingredients described herein can be selected and combined with a selection of any one of the gum rosin ingredients described herein.

Salt water is also an ingredient in the present composition. In one example, this salt water is simply sea water that is sourced from any sea or ocean or brackish water source. This seawater contains many natural ion ingredients that help to eradicate the unhealthy bacteria and also provide nutrients to a plant. The salt water ingredient as defined herein also includes any artificial seawater or other mixtures of water that include one or more of the primary ions of seawater including chloride, sodium, sulfates and magnesium among other optional common ions in sea water.

In certain embodiments, the antimicrobial composition comprises a surfactant. For example, in foliar applications, a surfactant is a benefit by improving the dispersion of the composition on plant leaves and branches as well as improving the absorption of the composition into the leaves and bark. One such class of surfactant is referred to as a benzyl quaternary compound. One specific surfactant is BTC 8358, which is a quaternary compound for formulation into a wide variety of institutional and industrial cleaning applications, water treatment, gas/oil drilling muds/packer fluids, gas/oil recovery injection water systems, gas/oil fracturing fluid systems and wood preservation. Applications include its use as Algaecides, Antimicrobials, Deodorizers, Disinfectants, Fungicides, Preservatives, Sanitizers, Swimming Pool Maintenance, and Water Treatment. The chemical description of the compound is alkyl dimethyl benzyl ammonium chloride. Other classes of acceptable surfactants include, but are not limited to, Polysorbates (e.g. Tween™), Sodium dodecyl sulfate (sodium lauryl sulfate), Lauryl dimethyl amine oxide, Cetyltrimethylammonium bromide (CTAB), Polyethoxylated alcohols, Polyoxyethylene sorbitan, Octoxynol (e.g. Triton X100™), N, N-dimethyldodecylamine-N-oxide, Hexadecyltrimethylammonium bromide (HTAB), Polyoxyl 10 lauryl ether, Brij 721™, Bile salts (sodium deoxycholate, sodium cholate), Polyoxyl castor oil (e.g. Cremophor™), Nonylphenol ethoxylate (e.g. Tergitol™), Cyclodextrins, Lecithin, and Methylbenzethonium chloride (e.g. Hyamine™) The surfactants are used in most formulations to hold the product on the applied surface as long as possible to achieve the maximum benefit of the product. By extending the contact with a plant's leaves, the absorption of nutrients and minerals in compounds in the formulations extends their effects on diseased trees and plants.

In certain embodiments, the antimicrobial composition comprises a growth stimulant. In some embodiments, when the present composition is used in a root drench or irrigation application, a growth stimulant is helpful. For instance, humic acids and fulvic acids and mixtures thereof can help make the plant become more healthy. Fulvic and humic acids are complex molecules which result from the decomposition of organic matter. Healthy soil naturally contains these acids. In contrast, unhealthy and heavily disturbed soils, in which this natural cycle has been disturbed, are depleted of these substances which are vital to the organic processes which result in plant health and vitality. Because most soil is not in an ideal condition, adding humic and fulvic acid directly to soil often results in drastic improvements and helps return it to its pristine natural state. Fulvic and humic acid may also work in the soil to bind up contaminants and render them inactive.

Alternative growth stimulants include the following: Humic (Trace) Minerals (organic, concentrated, liquid, powder), Fulvic (Trace) Minerals (organic, concentrated, liquid, powder), Diatomaceous earth minerals, Ionic Minerals, Trace Earth Minerals, and Rare Earth Minerals.

In further embodiments, any one of the growth stimulants described herein can be combined with a selection of any one of the pine oil ingredients described herein, as well as a selection of any one of the gum rosin ingredients described herein.

In certain embodiments, the antimicrobial composition comprises pine oil, a growth stimulant, such as humic or fulvic acid (or a mixture of both), and salt water. In further embodiments, the antimicrobial composition comprises pine oil and a growth stimulant without gum rosin.

In certain embodiments, the antimicrobial composition comprises seaweed (which is a source of bio-stimulants and minerals), and in particular comprises seaweed without gum rosin. In other embodiments, the antimicrobial composition comprises pine oil, gum rosin, and seaweed. The type of seaweed is not limited and in some embodiments is brown seaweed. In some embodiments, the brown seaweed is the same or similar to brown seaweed native to the Gulf Coast of Florida. The seaweed ingredient in the composition is not limited and can, for example, be in the form of a gel or having the consistency of a gel. In some embodiments, the seaweed is blended until it reaches gel consistency. It is then added to the pine oil mixture.

The foregoing components can be mixed together in concentrated or various dilute mixtures depending on how the composition will be applied to the plants at a grove or farm. Therefore, the relative amounts of composition components are listed and as claimed herein only in reference to the relative amounts of those components alone.

The following is a list of examples of formulations of the composition:

| | | |
|---|---|---|
| 1. | Pine Oil | 46% |
| | Sea Water (salt water) | 40 |
| | Humic/Fulvic | 3 |
| | Fumaric Resin | 1 |
| 2. | Pine oil | 40% |
| | Sea Water | 56 |
| | Humic/Fulvic | 3.5 |
| | Fumaric Resin | 0.5 |
| 3. | Sea Water | 58.39 |
| | Pine Oil | 17.64 |
| | Fumaric Resin | 0.15 |
| | Water | 21.46 |
| | Humic Acid | 1.18 |
| | Fulvic Acid | 1.18 |

In general, the respective ranges of the components is as follows. As above, the percentages are in volume and relative only to the other components in a concentrated mixture and not to any additional diluent that may carry the composition.

### Formula Ranges:

| | | |
|---|---|---|
| 1. Gum Rosin (e.g., Fumaric Resin) | 0.01-70% | range |
| | 0.1-40% | alternative range |
| 2. Pine Oil (e.g., El Pinol 85) | 0.5-75% | range |
| | 1.00-50% | alternative range |
| 3. Salt water | 15-95% | range |
| | 20-90% | alternative range |
| | 20-40% | alternative range |
| 4. Growth stimulant | 0.01-20% | range |
| (Humic/Fulvic acid) | 10-17% | alternative range |
| (optional component) | | |
| 5. Surfactant | 0.5-30% | range |

In certain embodiments of applications where the composition is diluted in water, the treatment ranges include the following volume of concentrated formula/composition versus water.
1. Foliar application ranges: 10-90 milliliters, or alternatively 5-200 milliliters of concentrated composition per gallon of water.
2. Root drench application ranges: 30-140 milliliters, or alternatively 10-200 milliliters of concentrated composition per gallon of water.
3. Irrigation application ranges: 10-90 milliliters, or alternatively 5-200 milliliters of concentrated composition per gallon of water.

Each of these types of plant applications are discussed below. Any one or more (together) of these applications may be used in accordance with the invention. These examples of composition application are directed to treatment of specified plants, but the applications will be similar for other plants as well with each application adjusted for the specific types of plants.

Foliar Spray application—Essentially all citrus in Florida receive foliar spray applications which consist of fungicides, insecticides, and/or nutritionals. Most foliar sprays are applied by airblast sprayers. These sprayers are generally pulled by tractors at 1-3 miles per hour. The tanks on the sprayers are generally 500-1000 gallons in size. There are some sprayers mounted on trucks. The sprayers consist of a 500-1000 gallon tank to hold the spray mix, multiple nozzles which are mounted on the rear of the sprayer. The nozzles are mounted adjacent and to the side of a large fan which propels the spray onto/into the canopy of the tree. The sprayers are driven between the rows of trees. There are a few smaller, low volume sprays used and some foliar sprays are applied by air. The smaller concentrate sprays apply from 50-150 gallons per acre and the spray planes apply 5-20 gallons per acre. Planes are generally used on the larger acreage groves.

Root Drench Application—A root drench, also referred to as a soil drench, is applied when the soil around the plant's base is slightly moist. Temporarily raking back mulch, leaves or other material covering the soil and the uppermost inch of soil within 1 foot of the plant's base limits the impact of evaporation on the chemicals applied to the soil, and it gets the chemical into the tree faster. The amounts of fertilizer and water used in a soil drench are typically calculated based on the concentration of the fertilizer and the area of soil it is used on. Pesticides and other chemicals used on trees are calculated based on the diameter of the tree's trunk and the manufacturer's recommendation for the chemical being used.

Irrigation Systems—Examples of irrigations systems that may be used for application of the microbial compositions are those generally known and used in Florida, and other systems known by persons of skill in the art, such as the following four types of systems, any one of which may be included in embodiments of the invention:
1. Microjets—Low volume systems with sprinklers adjacent to each tree and sometimes a sprinkler between two trees. The sprinklers cover areas from 10-20 feet in diameter. There are other known configurations. The gallonage applied and the irrigation schedule depends upon the desires of the grove owners. Usually 0.5-1.0 acre inches of water are applied at each irrigation. With the onset of HLB (greening) some growers apply multiple irrigations with less water per application. The water is supplied from wells in the grove and operated by large electric or diesel pumps. Fungicides, insecticides, and/or nutritionals and fertilizers are often injected into the system. The injection system is located near the pump. Injection is a very economical method for applying materials to the soil as a soil application or a drench. After the injection of materials early in the irrigation event, the irrigation event is continued to flush the irrigation lines and to apply the desired water to the grove.
2. Flood Irrigation—There are groves in south Florida that are irrigated by flooding. The trees are planted on raised beds with ditches on either side of the beds. Large volumes of water are pumped into the ditches or are supplied by canals and gravity fed. The ditches between the rows are slightly sloped in order for the water to travel down the ditches.
3. Overhead—This system was once widely used until the advent of microjets.
4. Seepage Irrigation—In the flatwoods areas of citrus culture (near the coasts and in south Florida), canals adjacent to the groves are flooded and the water seeps through the soil profile to the citrus trees.

### EXAMPLES

The following examples serve only to illustrate the invention and practice thereof. The examples are not to be construed as limitations on the scope or spirit of the invention.

### Example 1

Florida Valencia Grove Field Trial Aug. 25, 2018

### Location

Umatilla, Florida

### Crop Variety

Valencia Orange Trees (8′-10′ Feet in Height)
Planted Feb. 15, 2004

### Time Frame

Fruit was harvested on Apr. 22, 2019

The field trial began on Aug. 25, 2018 in a Valencia Grove in Umatilla, Florida. 20 randomly selected trees were selected for this trial. 10 trees were to be used to evaluate Treatment 1 formula W104. The remaining 10 trees from this select group of trees were to remain untreated.

It should be noted that the grove owner continued his standard treatment applications of fertilizers, pesticides, insecticides, fungicides, etc. on all his Valencia Orange trees in this grove (including the twenty trees in this field trial).

### Treatment Application Information

1^{st} Full Foliar spray—Aug. 25, 2018
1^{st} Root Drench (3′ Perimeter of each tree)—Aug. 25 2018
2^{nd} Full Foliar Spray—Sep. 12, 2018
2^{nd} Root Drench (3′ Perimeter of each tree)—Sep. 12, 2018
3^{rd} Root Drench (3′ Perimeter of each tree)—Oct. 7, 2018

Spray Equipment—CO2 Backpack with D8-45 Cone type nozzle at 40 PSI

One gallon of diluted treatment (45 milliliters concentrated formula/gallon of water) applied as a foliar spray and one gallon of diluted treatment (65 milliliters concentrated formula/gallon of water) applied within a three foot radius of the tree trunk as soil drench.

The material was additionally sprayed onto the soil from the trunk to the drip line with a hand sprayer. Growers might alternatively apply the soil application through microjet irrigation. Each micro jet covers various surface areas depending upon the grower. The approximate surface area of treatment would be 14-16 feet in diameter. The growers may apply the product using their herbicide applicator that would apply from the trunk of the trees to just outside the drip line of the trees; approximately a 6-8 foot radius from the trunk of the trees.

TABLE 1
Treatment 1 - W104

| | Valencia #2 Umatilla, FL FT |
|---|---|
| | Aug. 30, 2018 |
| Sea Water | 56.20% |
| water | 0.00% |
| El Pinol 85 | 40.03% |
| Resimal F-24 (Fumaric Resin) | 3.77% |
| Total Percentage | 100.00% |

### Protocol

The field trial was conducted using the Citrus Research Development Foundation's Field Trial Tree Evaluation Methods dated Mar. 11, 2016.

Initial evaluations and pictures were taken on Jun. 27, 2018 before any applications were made, with the purpose to establish a base line for future evaluations.

HLB-Mature leaves and expanded flush leaves were collected prior to any applications. The CT values for the old leaves indicated heavy citrus HLB greening on all the trees.

Fruit harvest was collected on Apr. 25, 2019. Each picking bag of fruit harvested from each tree was weighed, and total pounds of fruit per tree was calculated. Ten individual trees were harvested per treatment. The results are shown in Table 2.

### Field Trial Results

1) On Oct. 11, 2018 and Nov. 9, 2018, Treatment 1 trees had significantly more new flush than untreated trees. Often times with a great deal of flush on one date of evaluation will lead to less flush on the following evaluation date.

2) Ten randomly selected flushes were selected from each tree and their lengths were measured individually. Flushes from both sets of treated trees had slightly longer flushes compared to untreated trees. The evaluated data collected during the course of this trial, indicates that the tree vigor improved in the treated trees vs. the untreated trees. The increase of foliage vigor and new flush growth during the fall 2018 season is a particularly important indicator for the crop size during the 2019 harvest.

3) On average, the treated trees dropped significantly fewer fruit during this field trial compared to the untreated trees. The comparative fruit drop results indicate that the treated trees had higher harvest yields compared to untreated trees.

TABLE 2
Average % lower fruit drop of Treatment 1 compared to Untreated

31.20%

| | Average pounds of fruit |
|---|---|
| Treatment | per tree |
| WE 104 | 227.7 a 109% |
| Untreated | 208.1 a 100% |

Valencia field trials. 9.4% yield increase 8 months after the first application on 10 mature Valencia trees. 2.53 boxes per treated tree vs. 2.31 boxes per untreated tree.

Table 3 depicts the results of fruit drop and new flush measurements.

TABLE 3

| | | | New Flush | |
|---|---|---|---|---|
| Valencia | Fruit | | on ½ | New Flush |
| Trial | Drop | Fruit Drop | tree | on ½ |
| Year 1 | UnTreated | Treated | Treated | tree UnTR |
| Oct. 11, 2018 | 8.4 | 5.2 | 63.6 | 48.2 |
| Nov. 9, 2018 | | | 27.2 | 20.4 |
| Jan. 29, 2019 | 12.4 | 7.2 | | |
| Feb. 26, 2019 | 9.6 | 5.5 | | |
| Apr. 2, 2019 | 33.8 | 26.5 | | |
| Total to date | 64.2 | 44.4 | 90.8 | 68.6 |

| | | |
|---|---|---|
| % | 31.2% Less | 33% More Flush |
| improvement | Fruit Drop | compared to |
| | compared to | Untreated |
| | Untreated | |

Table 4 shows the results of a fruit quality analysis conducted on Mar. 18, 2019.

TABLE 4
Valencia Trial Year 1

| | | | | Net | % | Lbs | | | | % | Lbs | Number | |
|---|---|---|---|---|---|---|---|---|---|---|---|---|---|
| Valencia - | | Gross | | Juice | Difference | juice/ | | | Brix/ | Difference | Solids/ | of fruit to | |
| 70 Fruit | Gross | Wt/ | Juice | wt/ | Vs | 90 Lb | | Total | Acid | Vs | 90 Lb | fill 90-lb | |
| Mar. 18, 2019 | Wt | Fruit | wt | Fruit | Untreated | box | Acid | Brix | Ratio | Untreated | box | box | |
| Valencia - | | | | | | | | | | | | | |
| 70 Fruit | | | | | | | | | | | | | |
| Mar. 18, 19 | | | | | | | | | | | | | |
| Treat CS-P | 20.98 | 0.3 | 12.08 | 0.173 | 51.821 | 1.33 | 12.28 | 9.23 | 4.5% | 6.3636 | | 300 | 4.2% |
| | | | | | | | | | Sweeter | | | | increase |
| Untreated | 20.14 | 0.288 | 11.43 | 0.163 | 51.077 | 1.39 | 12.27 | 8.83 | | 6.2671 | FM* | 313 | |

*FM—“Failed maturity”: The ratio has to be over 9 to be considered mature fruit. The untreated sample had a ratio of 8.83, thus the fruit failed the maturity requirement. The treated samples 001 and 002 were above 9 ratio, thus they passed the maturity minimum.

### Example 2

A 40-acre field trial was conducted on Hamlin orange trees in commercial groves of Wauchula, Florida from November 2019 to January 2020. The orange trees were infected with HLB-Citrus Greening (Candidatus Liberibacter). Each acre contained 150 trees. The trees were treated with Composition 1 by micro-jet irrigation.

TABLE 5

| | Composition 1 |
|---|---|
| Humic/Fulvic | 0.0018% |
| Sea Water | 30.0000% |
| water | 52.2182% |
| El Pinol 85 | 17.6400% |
| Resimal F-24 (Fumaric Resin) | 0.1400% |
| Megara (GR) Oleoresin Gum | |
| Rosin/Gum Turpentine mixture) | |
| Mexican 360 Nanoparticle | |
| Total Percentage | 100.0000% |

Mexican 360 Nanoparticle refers to 360° Agrorocker fungicide by Nanofactor® in all Examples.

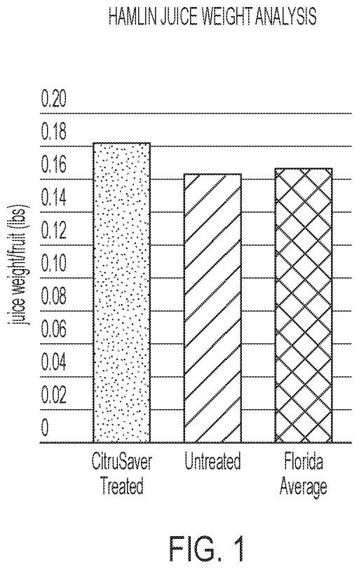

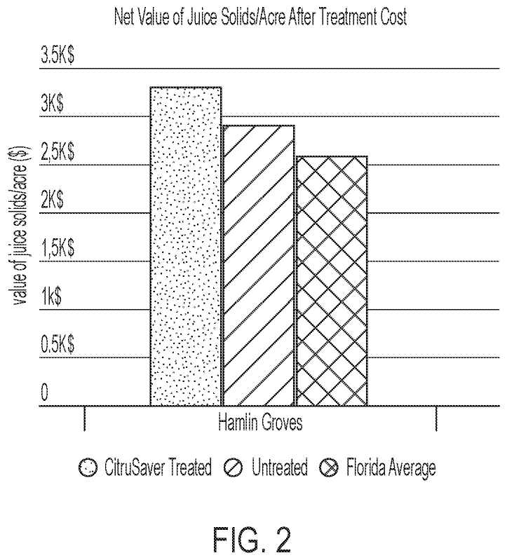

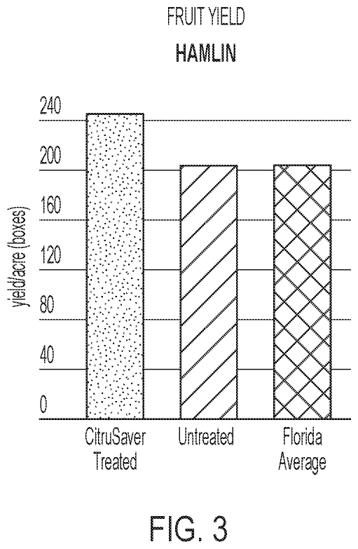

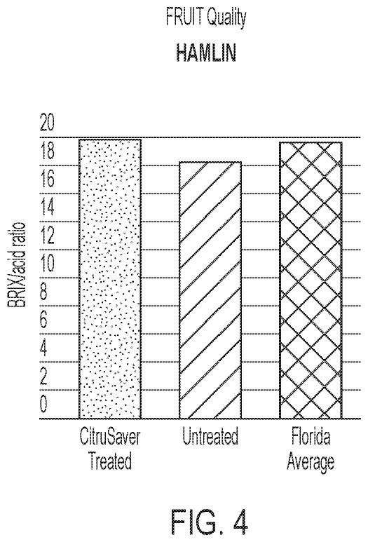

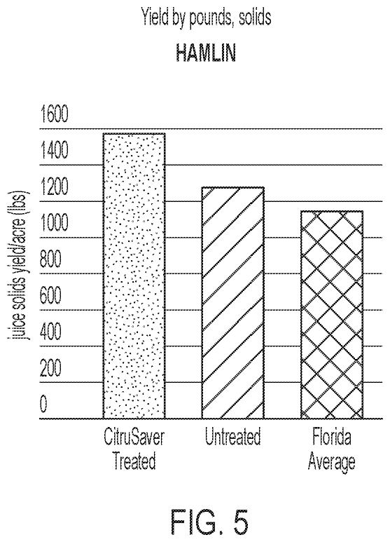

Eighty random fruits were picked from treated and untreated on Jan. 10, 2020. Fruit quality was analyzed on Jan. 17, 2020 by evaluating the following: juice weight (FIG. 1), fruit yield (FIG. 3), Brix/acid ratio (FIG. 4), and yield by pounds solids (FIG. 5). The net value of juice solids is depicted in (FIG. 2). Additional evaluations conducted on Jan. 17, 2020 are presented in Table 6.

TABLE 6
Wauchula Grove 40 acre Field Trial Nov. 6th, 2019 - Jan. 25, 2020
Year 1 Hamlin
Results from 80 Fruit Picked (Treated/Untreated) on Jan. 10, 2020

| | | | Florida |
|---|---|---|---|
| | | | State |
| | | | Average - |
| | Trees treated | | Early/Hamlin |
| | with | | (USDA |
| | Composition | Untreated | Stats for |
| | 1 Fertilizer | Trees | January 2020)* |
| Gross wt of 80 fruit (lbs) | 24.96 | 22.23 | 22.78 |
| Gross wt/Fruit (lbs) | 0.312 | 0.278 | 0.2848 |
| Juice wt of 80 fruit (lbs) | 14.47 | 12.92 | 13.19 |
| Net Juice wt/Fruit (lbs) | 0.1811 | 0.1619 | 0.1649 |
| % Difference Vs Untreated | 11.86% increase | | |
| Juice wt/90 lb box (lbs) | 52.175 | 52.308 | 52.1 |
| Acid | 0.62 | 0.66 | 0.57 |
| Total Brix | 12.26 | 12.01 | 10.69 |
| Brix/Acid Ratio | 19.77 | 18.2 | 19.57 |
| % Increase of Treated trees vs. | 8.63% | | |
| Untreated | | | |
| lbs of Solids/90 lb box | 6.3967 | 6.2822 | 5.6 |
| # Fruit per 90 lb box | 288 | 323 | 316 |
| % Increase of Treated trees vs. | 10.8% increase | | |
| Untreated | | | |
| # fruit/tree FL 01/2020 (USDA Stats)* | 775 | 775 | 775 |
| # boxes/tree | 2.69 | 2.4 | 2.45 |
| # boxes/acre (150 trees) | 432 | 360 | 368 |
| lbs Solids/acre (150 trees) | 2,763 | 2,262 | 2,061 |
| lbs Solids/acre compared to CitruSaver | 0 | −501 | −702 |
| % Difference CitruSaver Vs Untreated | | 22.15% Less | 34.0% Less |
| Estimated Value/acre @ current price | $3,233 | $2,647 | $2,411 |
| of $1.17/lb Solids** | | | |
| 8.4% Yield/lb solids increase due to | 2,995 | | |
| lower fruit drop as a result of | | | |
| CitruSaver Fertilizer applications | | | |
| Total estimated value of one acre | $3,504 | $2,647 | $2,411 |
| harvest @ $1.17/lbs Solids** | | | |
| Cost of CitruSaver Fertilizer to treat 1 | $369 | | |
| acre/150 trees in the Hamlin Grove | | | |
| ($45/gallon of CitruSaver) | | | |
| Estimated Net value of one acre/150 | $3,135 | | |
| trees in lbs solids after CitruSaver | | | |
| Fertilizer cost | | | |
| Estimated Net value increase of one acre | $488 | 18.4% Higher | |
| (150 trees) Hamlin grove acre treated | | value of | |
| with CitruSaver Fertilizer vs untreated | | treated vs | |
| Mosaic acre | | untreated | |
| Estimated Net value increase of one acre | $724 | | 30% Higher |
| (150 trees) Hamlin Grove acre treated | | | value of |
| with CitruSaver Fertilizer vs one acre | | | treated vs |
| according to Florida State average | | | Florida State |
| | | | Average |

*USDA National Agricultural Statistics Service - January 2020 Citrus Crop Test Results https://www.nass.usda.gov/Statistics_by_State/Florida/Publications/Citrus/Citrus_Forecast/2019-20/cit0120b.pdf
**2018/2019 price of lb solids was $2.86

One reported harvest from a 10-acre Valencia Grove yielded 1,200 boxes in 2020 compared to 800 boxes last year in 2019.

Table 7 shows fruit quality analysis results from the Wauchula trial.

TABLE 7
FRUIT QUALITY ANALYSIS
PERCENT IMPROVEMENT OF TREATED FRUIT VS. UNTREATED FRUIT
FLORIDA FERTILIZER FIELD TRIALS IN COMMERCIAL
GROVES INFECTED WITH HLB-CITRUS GREENING

| | | | Gross | Net | | | # Fruit Per |
|---|---|---|---|---|---|---|---|
| | | | Fruit | Juice | Fruit | Brix/ | 90 lb Box |
| | Trial | Trial | Weight | Weight | Solids | Acid | (treated/ |
| Species | Region | Year | (lbs) | (lbs) | (lbs) | Ratio | untreated) |
| Hamlin | Wauchula | 1 | 12% | 10% | 13% | 7% | 287/305 |

In 2020, the fruit quality analysis of the treated and untreated Hamlin tree plots in Wauchula, Florida showed that the treated fruit increased weight, improved in quality, and increased in pounds solids as compared to the fruit from the unttreated trees. These results were obtained in about 2 months of treatment by this mixture.

### Example 3

In 2019, irrigation-scale field trials were initiated in Groveland, Florida by applying Composition 1 to juvenile tangos (mandarin) trees as set forth below.

Rate:
1. One oz. of Composition 1 concentrate was mixed with one gallons of water per tree per application.
2. One gallon (128 oz.) of Composition 1 mixed with 40-128 gallons of water was used to treat 128 trees per application (depending on the grower irrigation water rate preferences, size of water storage container, etc.).
3. The mixture was used within 5 hours of mixing or, if not used during this period of time, mixture was re-agitated to guarantee complete mixing.
4. Where applicable, Composition 1 was able to applied using micro-sprinkler irrigation systems—using the same rate.
   Treatment Program: Block 105 is 13 acre with 303 trees per acre. Fifty percent of the acreage, which was 6.5 Acres or 1970 trees, was injected. This required 16 gallons of Composition 1. Composition 1 was diluted with approximately 50 gallons of water. Block 102 was 10 acres with 165 trees per acre. Fifty percent of the acreage, which is 5 acres or 825 trees, was injected, requiring 6.5 gallons of Composition 1. Composition 1 was diluted this with approximately 25 gallons of water. This was injected during a 30 to 40 minute irrigation cycle on both blocks.
5. Treatment 1 on Jun. 13, 2019 was applied in the system of choice.
6. Treatment 2/3 started 2-3 weeks later and was applied as a foliar application and a root drench.
7. Jun. 28, 2019—The Foliar application using the same rates of Composition 1 was applied during dry weather.
8. Jul. 5, 2019—The Root Drench application using the same rates of Composition 1 was also applied during dry weather.
9. Treatment 4—Jul. 15, 2019—The 4th Treatment was applied 3 weeks to a month after the 3rd Treatment depending on the weather, and was especially effective at the beginning of flush and was applied using the same rates of Composition 1.

The following results were obtained.

TABLE 8

| | | Canopy | | | |
|---|---|---|---|---|---|
| | Height of | width of | | Canopy | |
| | Untreated | UnTreated | Height of | Width of | |
| Tangos (Juveniles | (Sep. 10th, | (Sep. 10th, | Treated (Sep. | Treated (Sep. | |
| under 2 years old) | 2019) | 2019) | 10th, 2019) | 10th, 2019) | |
| Year 1 Trial | in Inches | In Inches | In Inches | In Inches | |
| Tree #1 | 73 | 50 | 80 | 56 | |
| Tree #2 | 51 | 50 | 74 | 60 | |
| Tree #3 | 56 | 55 | 60 | 65 | |
| Tree #4 | 52 | 45 | 73 | 61 | |
| Tree #5 | 55 | 49 | 88 | 67 | |
| Tree #6 | 52 | 58 | 72 | 64 | |
| Tree #7 | 74 | 56 | 59 | 48 | |
| Tree #8 | 49 | 44 | 55 | 47 | |
| Tree #9 | 62 | 46 | 57 | 51 | |
| Tree #10 | 76 | 54 | 52 | 53 | |
| TOTAL IN Inches | 600 | 507 | 670 | 572 | |
| of 10 Trees | | | | | |
| TOTAL IN FEET of | 50 | 42.25 | 55.83 | 47.67 | |
| 10 Trees | | | | | |
| AVERAGE | 5 | 4.225 | 5.58 | 4.77 | |
| HEIGHT/TREE IN | | | | | |
| FEET | | | | | |
| AVERAGE AREA/ | | | | | 26.62 |
| TREE IN FEET | | | | | |
| (TREATED) | | | | | |
| AVERAGE AREA/ | | | | | 21.125 |
| TREE IN FEET | | | | | |
| (UNTREATED) | | | | | |
| % IMPROVED | | | | | 26% |
| GROWTH OF | | | | | |
| TREATED | | | | | |
| TANGOS | | | | | |

### Example 4

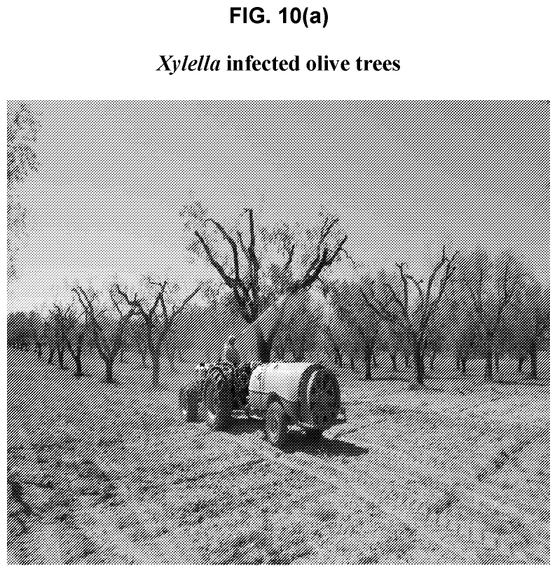

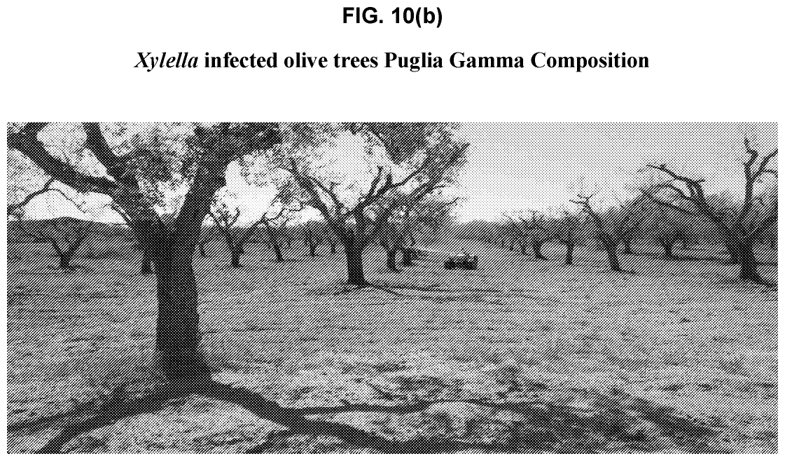

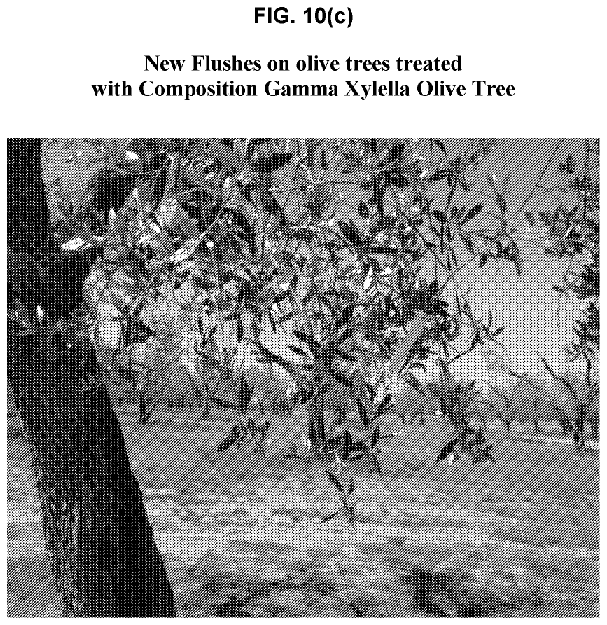

A field trial was conducted in Puglia, Italy on olive trees (Commercial Organic Olive Tree Grove—Ogliarola Variety 50-80 year old Trees) infected with Xylella fastidiosa (FIGS. 10(a) and 10(b)). Three different formulations of antimicrobial compositions (alpha, beta, and gamma) were applied as set forth below.

TABLE 9

| | Composition - alpha |
|---|---|
| | Olive Xylella FT |
| | 2.5 gallons |
| Humic/Fulvic | 0.0022% |
| Sea Water | 29.3000% |
| Water | 57.6200% |
| El Pinol 85 | 13.0000% |
| Resimal F-24 (Fumaric Resin) | 0.0778% |
| Megara (GR) Oleoresin Gum | |
| Rosin/Gum Turpentine mixture) | |
| Mexican 360 Nanoparticle | |
| Total Percentage | 100.0000% |

TABLE 10

| | Composition - beta |
|---|---|
| | Olive Xylella FT |
| | 2.5 gallons |
| Humic/Fulvic | 0.0044% |
| Citrus Peel | 12.4500% |
| Sea Water | 29.5500% |
| Water | 44.8500% |
| El Pinol 85 | 13.0000% |
| Resimal F-24 (Fumaric Resin) | 0.1456% |
| Megara (GR) Oleoresin Gum | |
| Rosin/Gum Turpentine mixture) | |
| Mexican 360 Nanoparticle | |
| Total Percentage | 100.00% |

TABLE 11

| | Composition - gamma |
|---|---|
| | Xylella FT |
| | 2.5 gallons |
| Sea Water | 30.2500% |
| Water | 56.1100% |
| El Pinol 85 | 6.7500% |
| Resimal F-24 (Fumaric Resin) | 0.1400% |
| Megara (GR) Oleoresin Gum | 6.7500% |
| Rosin/Gum Turpentine mixture) | |
| Mexican 360 Nanoparticle | |
| Total Percentage | 100.0000% |

The trial began in January 2020, with the first treatment applied on Mar. 6, 2020. Two experimental fields were selected for the activities within the biological (organic) olive groves in Squinzano (LE) site 1 with low infection degree and site 2 with medium degree of infection by the bacterium X. fastidiosa. Each field is composed by 30 treated plants and 10 control plants. In site 2, the rows of trees considered are alternated with rows of untreated trees. The plants were signed by a number and a letter for row: Composition α, β, γ and C (control).

Xylem fluid samples from treated and untreated olive trees were analyzed at the beginning and at the end of the trial period.

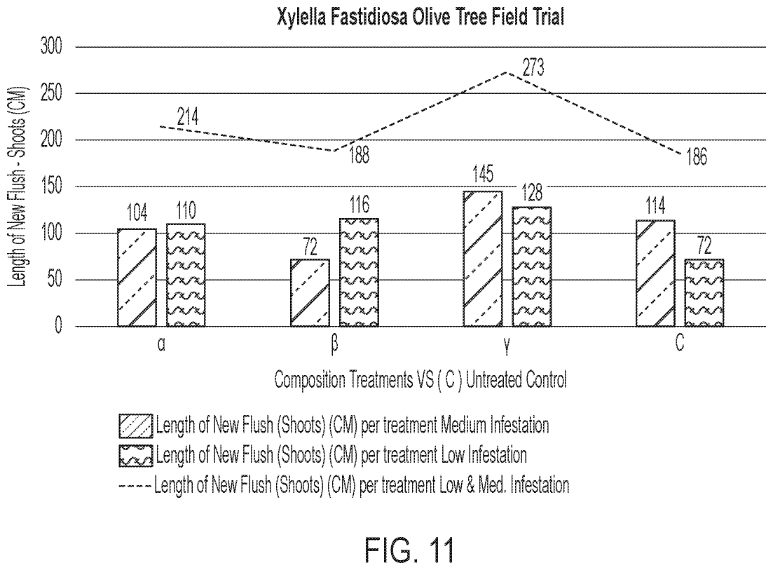

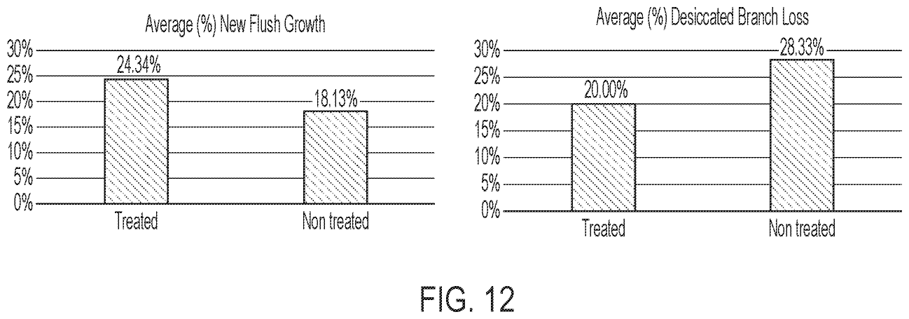

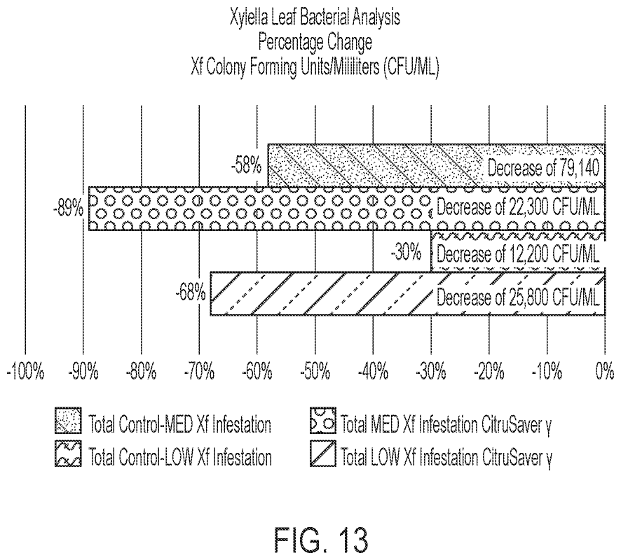

Results: Length measurements of new flush (shoots) were taken for olive trees (infected with Xylella fastidiosa at the start of trial) treated compared to untreated controls (FIG. 11). FIG. 10(c) shows new flush on an olive tree (Composition Gamma treatment). Branch growth & branch loss due to Xylella were also measured (FIG. 12). FIG. 13 shows the decreases, between Mar. 6, 2020 and May 25, 2020 sampling dates, of Xylella fastidiosa CFU/mL for Composition Gamma resulting from a leaf bacterial analysis on both treated and untreated (control) olive trees infected with Xylella fastidiosa.

Table 12 shows growth in foliage from March 6 to May 8, 2020 (the same 30 branches from each of the four categories were tagged and measured periodically).

TABLE 12

| | # Branches | Total length | |
|---|---|---|---|
| | w/new growth/ | of new | # Branch(es) |
| | % of 30 | growth (cm)/% | dieback*/ |
| Composition | tagged | improvement vs | % loss from 30 |
| Fertilizer | Branches | control (C) | tagged Branches |
| Alpha (α) | 12(40%) | 48(45%) | 1(3%) |
| Beta (β) | 15(50%) | 55(67%) | 1(3%) |
| Gamma (γ) | 18(60%) | 60(82%) | 0(0%) |
| Control (C) | 5(17%) | 33 | 5(17%) |
| Untreated | | | |

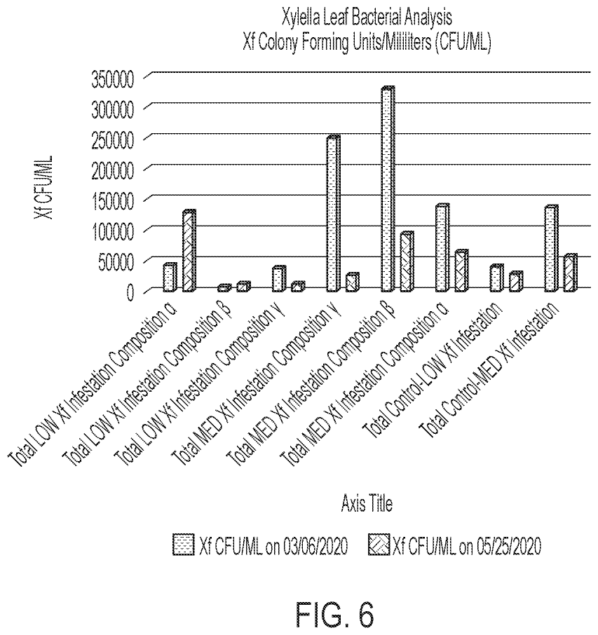

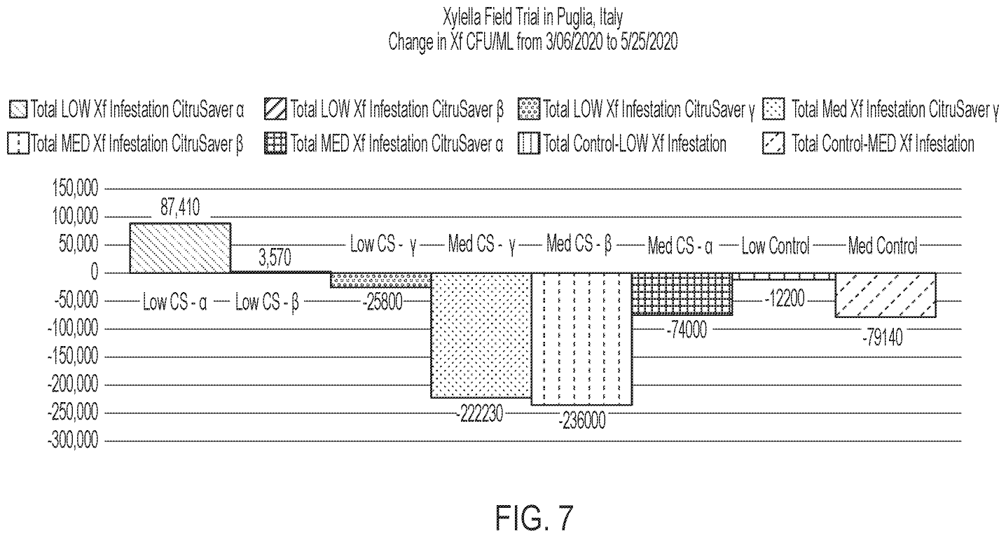

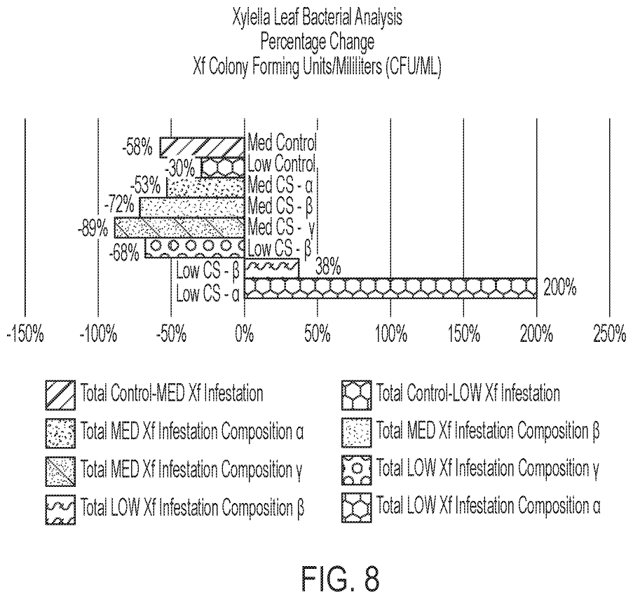

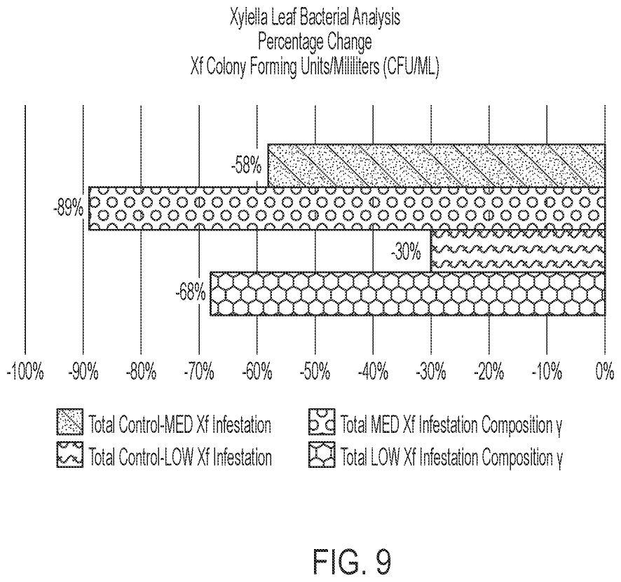

Treatment began on Mar. 6, 2020, with samples extracted from phloem fluid in trees on the same day prior to treatment. On May 26, 2020, sample were collected from the same trees. Analyses of leaf bacterial levels were conducted on these primary and secondary samplings. Results are shown in Table 13-17 and FIGS. 6-9.

TABLE 13

| | Xf CFU/ML on | Xf CFU/ML on |
|---|---|---|
| Treatment | Mar. 6, 2020 | May 25, 2020 |
| Total LOW Xf Infestation | 43,100 | 130,510 |
| Composition α | | |
| Total LOW Xf Infestation | 9,380 | 12,950 |
| Composition β | | |
| Total LOW Xf Infestation | 38,000 | 12,200 |
| Composition γ | | |
| Total MED Xf Infestation | 250,000 | 27,770 |
| Composition γ | | |
| Total MED Xf Infestation | 330,000 | 94,000 |
| Composition β | | |
| Total MED Xf Infestation | 139,000 | 65,000 |
| Composition α | | |
| Total Control-LOW Xf Infestation | 41,000 | 28,800 |
| Total Control-MED Xf Infestation | 137,140 | 58,000 |

TABLE 14

| | Change in Xf CFU/ML from |
|---|---|
| Treatment | Mar. 6, 2020 to May 25, 2020 |
| Total LOW Xf Infestation | 87,410 |
| Composition α | |
| Total LOW Xf Infestation | 3,570 |
| Composition β | |
| Total LOW Xf Infestation | −25800 |
| Composition γ | |
| Total MED Xf Infestation | −222230 |
| Composition γ | |
| Total MED Xf Infestation | −236000 |
| Composition β | |
| Total MED Xf Infestation | −74000 |
| Composition α | |
| Total Control-LOW Xf Infestation | −12200 |
| Total Control-MED Xf Infestation | −79140 |

TABLE 15

| Treatment | |
|---|---|
| Total LOW Xf Infestation Composition α | 200% |
| Total LOW Xf Infestation Composition β | 38% |
| Total LOW Xf Infestation Composition γ | −68% |
| Total MED Xf Infestation Composition γ | −89% |
| Total MED Xf Infestation Composition β | −72% |
| Total MED Xf Infestation Composition α | −53% |
| Total Control-LOW Xf Infestation | −30% |
| Total Control-MED Xf Infestation | −58% |

TABLE 16

| | |
|---|---|
| Total LOW Xf Infestation Composition γ | −68% |
| Total Control-LOW Xf Infestation | −30% |
| Total MED Xf Infestation Composition γ | −89% |
| Total Control-MED Xf Infestation | −58% |

TABLE 17

| | | Mar. 6, 2020 | | | | |
|---|---|---|---|---|---|---|
| | | samples | | May 26, 2020 | | |
| | | (pretreatment) | | samples | | |
| | samples | CFU/ml | | CFU/ml | | Remarks |
| 1 | LOW 5 α | 2.1 × 104 | 21,000 | 1.3 × 105 | 130,000 | + |
| 2 | LOW 8 α | 1.3 × 104 | 13,000 | 5.1 × 102 | 510 | |
| 3 | LOW 10 α | 9.1 × 103 | 9,100 | 0 | 0 | −−− |
| | Total LOW α | | 43,100 | | 130510 | 203% (+) |
| 4 | LOW 1β | 1.2 × 103 | 1,200 | 2.7 × 103 | 2,700 | + |
| 5 | LOW 4β | 9.8 × 102 | 980 | 2.5 × 102 | 250 | −−− |
| 6 | LOW 9β | 7.2 × 103 | 7,200 | 1.0 × 104 | 10,000 | + |
| | Total LOW β | | 9380 | | 12950 | 38% (+) |
| 7 | LOW 1γ | 2.4 × 104 | 24,000 | 1.2 × 103 | 1,200 | −−− |
| 8 | LOW 4γ | 1.0 × 104 | 0 | 0 | 0 | |
| 9 | LOW 7γ | 1.4 × 104 | 14,000 | 1.1 × 104 | 11,000 | − |
| | Total LOW γ | | 38000 | | 12200 | 68% (−) |
| 10 | LOW contr 1 | 1.9 × 104 | 19,000 | 2.4 × 104 | 24,000 | + |
| 11 | LOW contr 5 | 2.2 × 104 | 22,000 | 0 | 0 | −−−− |
| 12 | LOW contr 7 | 0 | 0 | 4.8 × 103 | 4,800 | + |
| | Total Control-LOW | | 41000 | | 28800 | 30% (−) |
| 13 | MED contr 1 | 4.5 × 104 | 45,000 | 1.3 × 104 | 13,000 | −− |
| 14 | MED contr 3 | 9.2 × 104 | 92,000 | 2.5 × 104 | 25,000 | −− |
| 15 | MED contr 8 | 1.4 × 102 | 140 | 2.0 × 104 | 20,000 | + |
| | Total Control-MED | | 137140 | | 58000 | 58% (−) |
| 16 | MED 2γ | 6.2 × 104 | 62,000 | 2.7 × 102 | 270 | −−−− |
| 17 | MED 6 γ | 4.8 × 104 | 48,000 | 2.2 × 104 | 22,000 | −− |
| 18 | MED 10 γ | 1.4 × 105 | 140,000 | 5.5 × 103 | 5,500 | −−− |
| | Total MED γ | | 250000 | | 27770 | 89% (−) |
| 19 | MED 6 β | 1.2 × 105 | 120,000 | 3.4 × 104 | 34,000 | −− |
| 20 | MED 8 β | 1.1 × 105 | 110,000 | 4.3 × 104 | 43,000 | −− |
| 21 | MED 10 β | 1.0 × 105 | 100,000 | 1.7 × 104 | 17,000 | −− |
| | Total MED β | | 330000 | | 94000 | 72% (−) |
| 22 | MED 2 α | 4.5 × 104 | 45,000 | n.d. | 0 | −−−− |
| 23 | MED 4 α | 6.1 × 104 | 61,000 | 5.0 × 104 | 50,000 | − |
| 24 | MED 9 α | 3.3 × 104 | 33,000 | 1.5 × 104 | 15,000 | −− |

| | | | |
|---|---|---|---|
| Total MED α | 139000 | 65000 | 53% (−) |

(n.d. = 0-102 CFU/ml)
Arabic numbers in the Table 17 denotes tree number.

To the surprise of the inventors, Composition Gamma obtained the best field tested results against Xylella fastidiosa in olive trees. Additionally, Composition Gamma also unexpectedly performed better than Composition Beta against the Xylella fastidiosa disease.

These results show positive outcomes within 3 months of treatment on mature low and medium (Xf) infected olive trees. Treated Xf infected olive trees have produced significantly more new foliar flush (shoots) (up to 47% more shoots than the untreated Xf “control” olive trees). One of field trials resulted in lowering the branch desiccation of treated Xf olive trees compared to untreated Xf olive trees (15% in treated trees compared to 28% in untreated trees). One of the treatments applied to “low infected” Xf olive trees did not lose any branches to desiccation during the three months of field research. Laboratory analysis of leaves collected from treated Xf infected olive trees also confirmed positive response to these natural treatments. Within three months, the lab analysis of leaves collected in March and May from the same Xf olive trees determined that the treatments lowered the Xf bacterial colony forming units by as much as 89%.

In addition, a metabolomic analysis was conducted on control and treated olive trees. The aim of the study was to measure primary metabolites, such as polyols and simple sugars, amino acids, organic acids, plant hormones and secondary metabolites, which play a pivotal role in plant growth and resistance to stresses (Rellán-Álvarez et al., 2011; Lowe-Power et al., 2018; Sofo et al., 2019b). Xylem sap was collected from shoots of olive trees in February and May 2019 from three control plants and three treated plants for each plot.

The treated xylem fluid results were positive compared to the untreated xylem fluid samples. In one sampling, 75 metabolites were revealed for each site considered. Principal groups identified were: antioxidants, cycle intermediates of krebs, sugars, amino acids. Table 18 sets forth the metabolites that were separated in each sample of LOW field and MEDIUM field.

TABLE 18

| | | LOW | LOW | LOW | LOW | MED | MED | MED | MED |
|---|---|---|---|---|---|---|---|---|---|
| | | 1 | 2 | 3 | 4 | 5 | 6 | 7 | 8 |
| Metabolites | | a | b | y | c | C | Y | B | A |
| D-Arabitol | sugars | 10 | 40 | 60 | 60 | 40 | 20 | 70 | 100 |
| L-Asparagine | aa | 100 | 70 | 60 | 70 | 40 | 30 | 10 | 20 |
| glyceric acid | precursor aa | 80 | 10 | 70 | 100 | 50 | 30 | 30 | 40 |
| D-Fructose | sugars | 20 | 20 | 60 | 60 | 40 | 30 | 100 | 70 |
| L-sorbose | sugars | 20 | 20 | 60 | 60 | 40 | 30 | 100 | 70 |
| beta-D-Glucose | sugars | 30 | 10 | 40 | 50 | 80 | 30 | 60 | 100 |
| alpha-Lactose | sugars | 100 | 20 | 80 | 60 | 50 | 40 | 40 | 10 |
| Maltose | sugars | 50 | 20 | 40 | 40 | 10 | 60 | 70 | 100 |
| Shikimic acid | precursor aa | 70 | 10 | 50 | 100 | 60 | 20 | 40 | 40 |
| 2-Oxoglutaric | Krebs | 20 | 70 | 10 | 40 | 40 | 70 | 100 | 50 |
| Fumaric acid | Krebs | 60 | 40 | 50 | 80 | 100 | 10 | 40 | 30 |
| L-Iditol | sugars | 20 | 10 | 40 | 80 | 60 | 30 | 50 | 100 |
| D-Lyxose | sugars | 50 | 40 | 60 | 100 | 70 | 40 | 10 | 20 |
| D-Arabinose | sugars | 50 | 30 | 60 | 100 | 70 | 40 | 10 | 30 |
| Inositol | sugars | 100 | 30 | 60 | 50 | 70 | 10 | 40 | 40 |
| isothreonic acid | | 60 | 10 | 70 | 100 | 50 | 30 | 40 | 40 |
| phosphate | | 10 | 80 | 40 | 30 | 50 | 40 | 60 | 100 |
| N Acetyl D Glucose | sugars | 60 | 10 | 100 | 70 | 50 | 40 | 20 | 30 |
| Galactinol | sugars | 100 | 50 | 60 | 30 | 40 | 60 | 10 | 40 |
| L-Threonine | aa | 60 | 30 | 50 | 70 | 100 | 40 | 10 | 40 |
| L-Leucine | aa | 80 | 40 | 100 | 60 | 50 | 10 | 20 | 40 |
| Aconitic acid | Krebs | 60 | 40 | 100 | 20 | 70 | 30 | 10 | 50 |
| L-Proline | aa | 80 | 50 | 100 | 30 | 10 | 40 | 40 | 60 |
| Meta - Tyrosine | aa | 10 | 60 | 20 | 40 | 40 | 60 | 70 | 100 |
| N-acetylmannose | sugars | 80 | 30 | 100 | 60 | 10 | 60 | 40 | 30 |
| Dopamine | | 40 | 40 | 100 | 50 | 10 | 70 | 70 | 20 |
| D-Glucose 6 ph | sugars | 50 | 40 | 100 | 70 | 60 | 40 | 30 | 10 |
| shikinic acid | | 70 | 10 | 60 | 100 | 60 | 20 | 40 | 40 |
| D-Ribose | sugars | 50 | 10 | 40 | 40 | 60 | 70 | 30 | 100 |
| L-Ascorbic acid | antiox | 40 | 10 | 70 | 40 | 70 | 50 | 30 | 100 |

### Example 5

A field trial was conducted in Groveland, Florida on 25-yr old grapefruit trees. Composition 1 was tested in this trial.

The first irrigation applications were applied on Jun. 13, 2019. The final irrigation applications were applied on Jul. 15, 2019.

The following results were obtained.

TABLE 19

| Mature Grapefruit (20+ | Fruit Drop 10 | Fruit Drop 10 Treated |
|---|---|---|
| years old) Year 1 Trial | UnTreated Trees | Trees |
| Aug. 20, 2019 | 26 | 14 |
| Sep. 10, 2019 | 173 | 102 |
| Total to date | 199 | 116 |
| % improvement | | 42.00% |
| | Flushes on | |
| | UnTreated trees | Flushes on Treated |
| Grapefruit Flush Count | measured on | Trees measured on |
| on ½ tree | Sep. 10, 2019 | Sep. 10, 2019 |
| Tree #1 | 16 | 23 |
| Tree #2 | 16 | 15 |
| Tree #3 | 14 | 12 |
| Tree #4 | 15 | 14 |
| Tree #5 | 18 | 14 |
| Tree #6 | 4 | 15 |
| Tree #7 | 14 | 22 |
| Tree #8 | 17 | 27 |
| Tree #9 | 15 | 21 |
| Tree #10 | 16 | 14 |
| Total flushes on | 145 | 177 |
| Sep. 10, 2019 | | |
| % Improvement of | | 22% |
| Treated vs Untreated | | |

### Example 6

A field trial was initiated in Sicily, Italy (Catania and Syracuse) on Tarocco Blood orange trees infected with Citrus tristeza virus (CTV) (Severe Isolate SY-568).

The following three compositions were tested.

TABLE 20

| | Composition S- (α) alpha |
|---|---|
| | Citrus Tristeza Virus |
| | 2 gallons |
| Humic/Fulvic | 0.0044% |
| Citrus Peel | 10.7000% |
| Sea Water | 30.3746% |
| Water | 48.2210% |
| El Pinol 85 | 10.7000% |
| Resimal F-24 (Fumaric Resin) | |
| Megara (GR) Oleoresin Gum | |
| Rosin/Gum Turpentine mixture) | |
| Mexican 360 Nanoparticle | |
| Total Percentage | 100.0000% |

TABLE 21

| | Composition S- (β) beta |
|---|---|
| | Citrus Tristeza Virus |
| | 2 gallons |
| Humic/Fulvic | 0.0022% |
| Sea Water | 34.4900% |
| Water | 38.4078% |
| El Pinol 85 | 27.1000% |
| Resimal F-24 (Fumaric Resin) | |
| Megara (GR) Oleoresin Gum | |
| Rosin/Gum Turpentine mixture) | |
| Mexican 360 Nanoparticle | |
| Total Percentage | 100.0000% |

TABLE 22

| | Composition S- (γ) gamma |
|---|---|
| | Citrus Tristeza Virus |
| | 2 gallons |
| Humic/Fulvic | 0.0022% |
| Sea Water | 34.4890% |
| Water | 38.4000% |
| El Pinol 85 | 27.1000% |
| Resimal F-24 (Fumaric Resin) | |
| Megara (GR) Oleoresin Gum | |
| Rosin/Gum Turpentine mixture) | |
| Mexican 360 Nanoparticle | 0.0088% |
| Total Percentage | 100.0000% |

Protocol:
Variety: Tarocco—Blood Orange—sour root stock—a variety that is native to Sicily
Age: 4 years old citrus trees in a Conventional (non-organic) commercial grove
CTV—“Severe Isolate” originated in California—SY 568, a highly virulent strain from University of California—Riverside by indexing (graft transmission) in a citrus host range.
Root application Method—Applied using a Microjet irrigation system
Number of Trees—30 trees treated with Composition S-alpha, S-beta, and S-gamma; 10 trees untreated control
Fruit will be harvested in November 2020—fruit weight and quality data will also be analyzed
First application May 4th 2020
Second Application May 20th 2020
First field trial foliar vigor photo documentation Jun. 8 2020

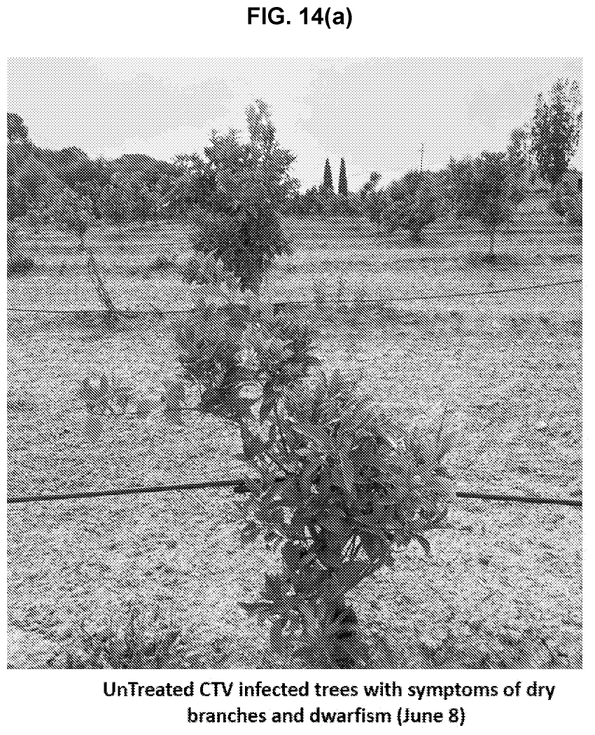

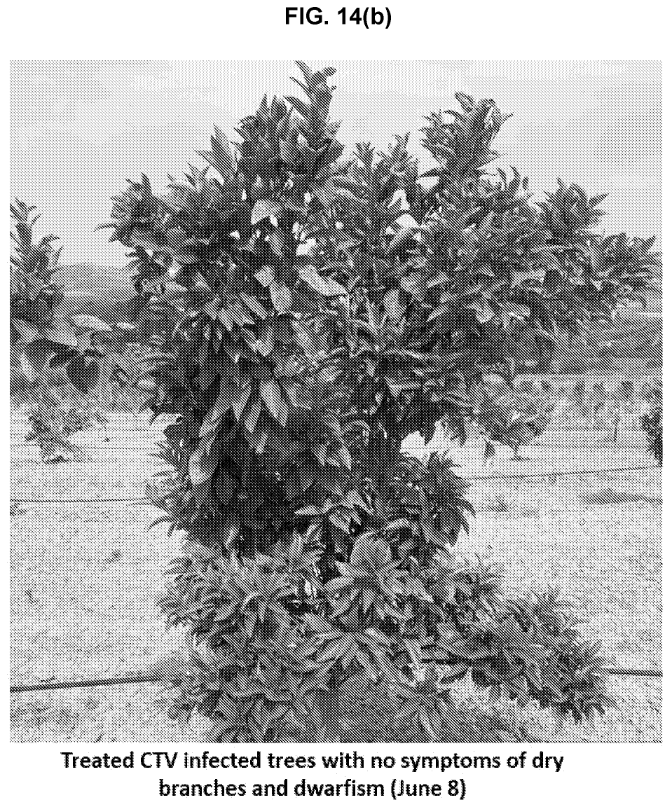

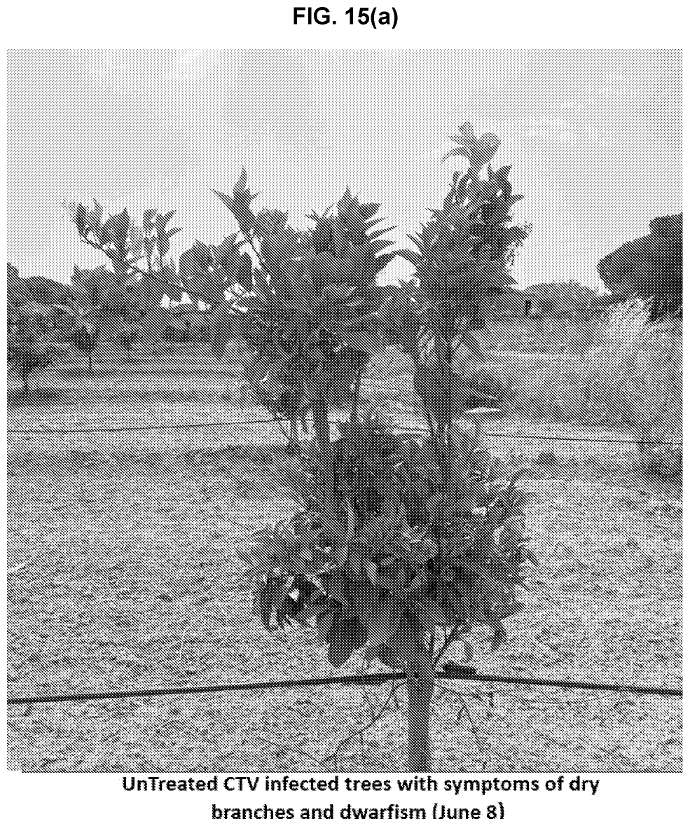

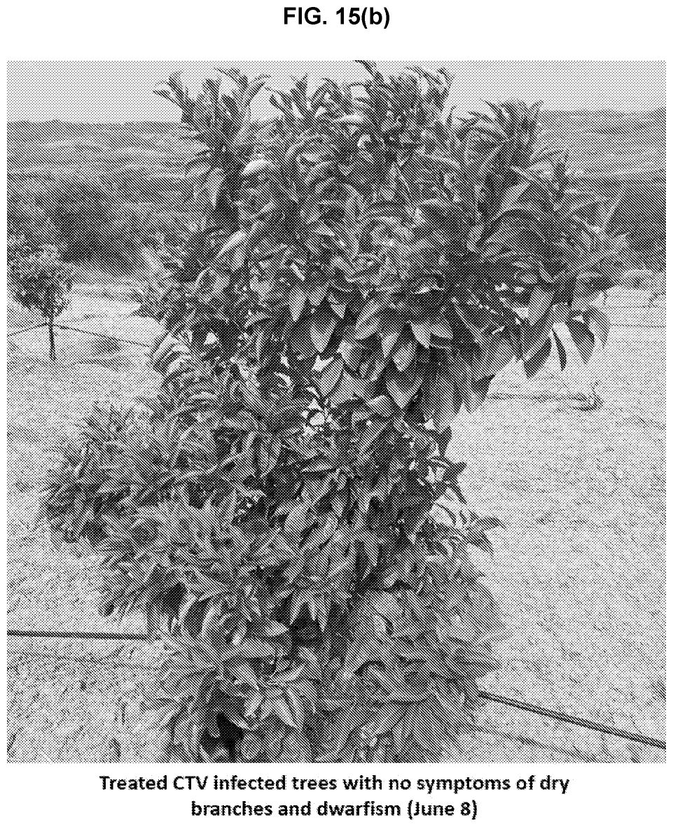

A visual evaluation on Jun. 8, 2020 found:
1) Treated trees had more new flush compared to the untreated trees
2) Treated trees had more foliar vigor compared to the untreated trees
3) Treated CTV infected trees showed no symptoms of dry branches and dwarfism (FIGS. 14(b) and 15(b)).
4) Untreated CTV infected trees all exhibit typical CTV symptoms of dry/dying branches and dwarfism (FIGS. 14(a) and 15(a)).
5) All treated trees had new fruit buds (none of the untreated trees had produced any fruit by this date).

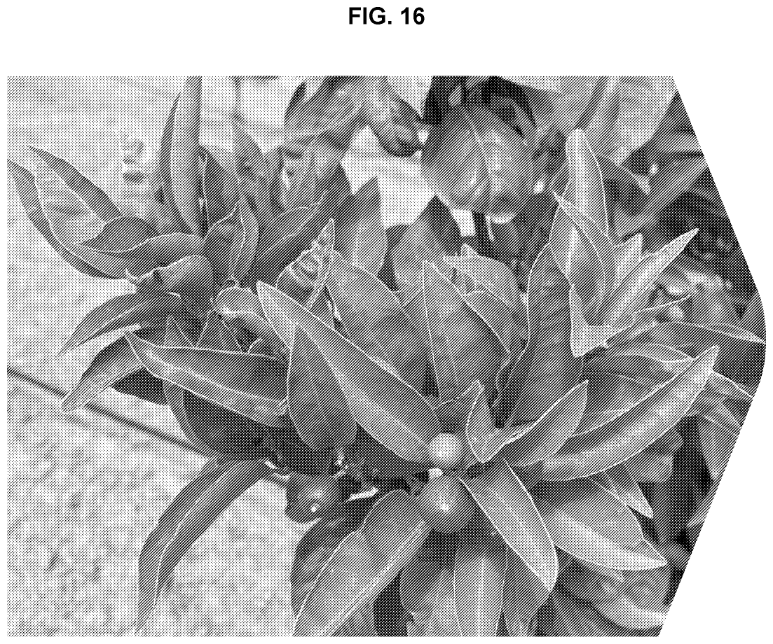

CTV-infected citrus trees treated exhibited more new flush, more foliar vigor, and no branch dieback symptoms as compared to the untreated citrus trees (FIG. 16). Furthermore, new fruit buds were observed only on treated citrus trees. (FIG. 16).

### Example 7

Candida auris is a fungal component which exacerbates the disease caused by X. fastidiosa by taking advantage of the stressed tree and killing it. An assay was performed to determine if Pine Oil, 85% (El Pinol 85 (T&R Chemicals)) as an ingredient in a test substance is capable of reducing Candida auris on solid, nonporous surfaces. The test substance is made up of 19.9% of the El Pinol 85 ingredient. To pass the assay, the product must reduce C. auris counts on the surface by five logs in under ten minutes.

Protocol: A suspension of C. auris is combined with a soil-mimicking solution (BSA, mucin, and yeast extract) then dried on the surface of metal disks to mimic a contaminated surface. 50 μl of the test substance is then spotted on top of the C. auris and incubated for 10 minutes. Samples are then transferred to a sufficient volume of broth so as to dilute out the test substance to prevent further activity during C. auris enumeration. The prevention of further activity is validated by a neutralization assay. The vials containing the disks (with C. auris and test/control substance) and broth are shaken vigorously to disperse the C. auris from the disk into the liquid broth. C. auris is enumerated in treatment groups by pouring the broth from each treatment vial over filters to capture all C. auris cells. The filter is then placed on a growth plate and incubated for 120 hours at 30° C. At this point, C. auris colonies are counted. It is assumed that all C. auris from the disk have been dispersed into the broth and captured on the filter. Thus, the number of colonies on the filter is the number of C. auris cells surviving after treatment with the test substance. This filtration method is only required for the treatment groups because the C. auris counts are too low to be detected via direct dilution plating of the broth. C. auris is enumerated in the control groups by direct dilution plating of the broth. 10 μl of the broth and 10 μl of a 10× dilution of the broth is plated then incubated for 72 hours at 30° C. The number of colonies in the dilutions are used to back-calculate the number of colonies in the entire volume of broth. This is assumed to be the number of C. auris cells on each disk. For the assay to be valid, this number must be between 105-106 cells. To pass the activity assay, the average number of C. auris cells from the treatment group must be at least five logs lower than the average number of C. auris cells from the control group.

Preliminary results showed that no colonies had appeared with the test substance. These laboratory results show that, surprisingly, the pine oil of the antimicrobial composition is effective against C. auris.

### Example 8

Trials on juvenile murcotts (hybrid mandarin-orange variety) were initiated. The treated murcotts had HLB symptoms, including lumpy yellowing leafs.

Prior to treatment with the below antimicrobial compositions, murcott trees were treated with Round-Up product (glyphosate).

Samples of roots were collected before and after application of Composition 1 by root drench. After application of Composition 1, it was discovered and surprisingly observed that glyphosate residue on tree roots disappeared.

The juvenile murcott trees were also treated with Composition 2. The seaweed in this composition was brown seaweed (Gulf Coast, Florida). It was blended until it reached gel consistency. It was then added to the pine oil mixture. Surprisingly, after only four to five days after treatment of the antimicrobial composition containing seaweed with no gum rosin, flattened, level, and shiny green leaves with no sign of HLB symptoms were observed.

TABLE 23

| | Composition 2 - Murcotts |
|---|---|
| | Aug. 4, 2019* |
| Humic/Fulvic | |
| Seaweed | 6.8000% |
| Sea Water | 20.5000% |
| Water | 56.0000% |
| El Pinol 85 | 16.7000% |
| Resimal F-24 (Fumaric Resin) | |
| Megara (GR) Oleoresin Gum | |
| Rosin/Gum Turpentine mixture) | |
| Mexican 360 Nanoparticle | |
| Total Percentage | 100.0000% |

The two antimicrobial compositions below were also applied as treatments to juvenile murcott trees.

TABLE 24

| | Composition 3- Murcotts |
|---|---|
| | Nov. 1, 2018 |
| Humic/Fulvic | 1% |
| Sea Water | 43% |
| Water | 5.88% |
| El Pinol 85 | 50.01% |
| Resimal F-24 (Fumaric Resin) | 0.11% |
| Megara (GR) Oleoresin Gum | |
| Rosin/Gum Turpentine mixture) | |
| Mexican 360 Nanoparticle | |
| Total Percentage | 100.00% |

TABLE 25

| | Composition 4- Murcotts |
|---|---|
| | Nov. 1, 2018 |
| Humic/Fulvic | 1% |
| Sea Water | 55.20% |
| Water | |
| El Pinol 85 | 40.03% |
| Resimal F-24 (Fumaric Resin) | 3.77% |
| Megara (GR) Oleoresin Gum | |
| Rosin/Gum Turpentine mixture) | |
| Mexican 360 Nanoparticle | |
| Total Percentage | 100% |

### Example 9

In ongoing trials in Greece (initiated in 2019), various trees and crops with visible phyto stressed symptoms, including yellowing/withering leaves, branch desiccation, trunk fungus, clear fluid droplets forming from fruit and branches (symptoms of bacterial infections), were treated with Composition 5. The treated trees and crops were olive trees, almond trees, walnut trees, pear trees, plum trees, cherry trees, grape vines, and a fig tree.

Reversal of the disease symptoms were observed. In particular, larger and healthier leaves were achieved with the treatments.

TABLE 26

| | Composition 5 |
|---|---|
| | Greece July/August 2019 |
| Humic/Fulvic | 0.0033% |
| Sea Water | 58.0000% |
| Water | 17.7167% |
| El Pinol 85 | 17.6400% |
| Resimal F-24 (Fumaric Resin) | 0.1400% |
| Megara (GR) Oleoresin Gum | 6.5000% |
| Rosin/Gum Turpentine mixture) | |
| Mexican 360 Nanoparticle | |
| Total Percentage | 100.0000% |

These preliminary field tests conducted using Composition 5 revealed highly surprising findings. The almond tree treated with this composition produced the only edible almonds in 2019. An unconfirmed bacterial/fungal pathogen (suspected to by Pseudomonas) has infected all the almond trees in this village located in Peloponessos, Greece. Most of the almond trees in this village have already succomed to this pathogen included some that were over 250 years old. Furthermore, a dramatic improvement was witnessed in the “stressed” pear tree treated with this composition. The treated pear tree showed improved foliar color and vigor within 15 days of treatment. When the pears from the treated and untreated trees were harvested, it was found that treated pears were bigger, juicier, and had no signs of imperfections as compared to the untreated pears. It was also surprisingly observed that some of the grapes from the treated grape vines ripened over 30 days ahead of typical harvest. Grapes were grown in that region for at least three generations. It was reported that this phenomenon caused by the treatment had not been seen as long as the grapes were under care for grapevines for over 50 years. It was also observed that the olive trees responded very well to the treatments of this mixture. The foliar vigor improved within 30 days of treatment, and the harvested olives were bigger, healthier, with no signs of imperfections as compared to previous harvests before this treatment.

In addition to the above Examples, unexpectedly, in a 103-acre HLB-infected Valencia field trial (Immokalee, Florida), the trees treated with this mixture produced visibly more new flush and foliar vigor within 30 days of application than the untreated trees in the grove. It was observed that this level of response was not witnessed from any other treatment for HLB that they have tested to date. In Parish, Florida, the 10-acre Valencia grove, treated with the composition for two consecutive seasons, had a 50% increased yield in 2020 as compared to 2019. Additionally, it was surprising that this mixture was the only “fertilizer” product used in that grove prior to the 2020 harvest. It should be noted that agricultural authorities in Florida reported that the Valencia groves lost up to 50% of their harvest to fruit drop in 2020. Some Florida growers reported that their Valencia groves dropped so much fruit, that it not even economical for them to pick the fruit that had not dropped.

The above Examples and field reports demonstrate the highly surprising discoveries in the responses of various pathogen-infected trees treated with the inventive antimicrobial compositions. Further, Examples 1-6, 8, and 9 show that the antimicrobial compositions of the instant invention reverse symptoms of the respective microbial disease under testing. This finding was surprising in view of the substantial challenges and failures in the art using prior compositions to mitigate and treat bacterial diseases in fruit crops.

Other than in the examples and figures herein, or unless otherwise expressly specified, all of the numerical ranges, amounts, values, ratios, and percentages, may be read as if prefaced by the word “about” even though the term “about” may not expressly appear with the value, amount, range, ratio, etc. In addition, when numerical ranges are set forth herein (even when prefaced with the word “within”), these ranges are inclusive of the recited range end points (i.e., end points may be used). Furthermore, any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

While this invention has been particularly shown and described in the specification and figures with references to preferred embodiments thereof, in light of the present disclosure it will be understood by persons skilled in the art that various changes in form and details may be made therein without departing from the scope of the invention encompassed by the appended claims.

1-28. (canceled)

29. A method of treating a disease in a plant infected with a microbial pathogen, the method comprising a step of applying to the plant a composition obtained by diluting a concentrate with a diluent, wherein said concentrate comprises:
a) gum rosin in an amount of from about 0.01% to about 70% by volume,
b) pine oil in an amount of from about 0.5% to about 75% by volume, and
c) salt water in an amount of from about 15% to about 95% by volume.

30. The method of claim 29, wherein the concentrate comprises:
a) gum rosin in an amount of from about 0.1% to about 40% by volume,
b) pine oil in an amount of from about 1% to about 50% by volume, and
c) salt water in an amount of from about 20% to about 40% by volume.

31. The method of claim 29, wherein the diluent is water.

32. The method of claim 29, wherein the plant is a citrus tree, olive tree, almond tree, or grapevine.

33. The method of claim 32, wherein the disease is citrus greening (HLB), citrus canker, root rot, quick decline syndrome, Pierce's disease, or Citrus Variegated Chlorosis.

34. The method of claim 29, wherein the microbial pathogen is a gram-negative bacteria, viral pathogen, or fungi.

35. The method of claim 34, wherein the gram-negative bacteria is Xylella fastidiosa, Candidatus Liberibacter, Pseudomonas spp., or Xanthomonas spp.

36. The method of claim 34, wherein the viral pathogen is Citrus tristeza virus.

37. The method of claim 34, wherein the fungi is Candida auris or Phytophthora spp.

38. The method of claim 29, wherein the concentrate further comprises a surfactant in an amount of from about 0.05% to about 30% by volume.

39. The method of claim 29, wherein the concentrate further comprises a growth stimulant in an amount of from about 0.1% to about 20% by volume.

40. The method of claim 29, wherein the concentrate further comprises seaweed.

41. The method of claim 40, wherein the seaweed is brown seaweed.

42. The method of claim 40, wherein the seaweed is present in an amount of from about 0.01% to about 70% by volume.

43. The method of claim 29, wherein the composition is applied to the plant foliage, plant roots, or both.

44. The method of claim 43, wherein the application method is a foliar application, root drench application, irrigation application, or any combination of these applications.

45. The method of claim 29, wherein application of the composition mitigates, reverses, or eliminates at least one symptom of the disease.

46. The method of claim 45, wherein the at least one symptom of the disease is phloem plugging or fruit drop.

47. The method of claim 45, wherein the at least one symptom of the disease is root rot, flagging, chlorosis, twig or limb dieback, green fruit, misshapen fruit, or bitter fruit.

48. The method of claim 29, wherein application of the composition improves fruit quality compared to an untreated plant.

49. The method of claim 48, wherein fruit quality is measured by pounds solids, gross weight per fruit, value of juice solids/acre, net juice weight per fruit, number of fruit per 90 lb box, or Brix/Acid ratio.
